(19) United States
(12) Patent Application Publication
(10) Pub. No.: US 2007/0042106 A1
(43) Pub. Date: Feb. 22, 2007

(54) High Protein Food Bars Comprising Sugar Alcohols and Having Improved Texture and Shelf-Life

(75) Inventors: Thomas J. Wagner, Hillsboro, MO (US); Kenneth Bopp, St. Peters, MO (US); Myong J. Cho, Chesterfield, MO (US)

Correspondence Address: SOLAE, LLC, P. O. BOX 88940, ST. LOUIS, MO, 63188, US

(73) Assignee: Solae, LLC, St. Louis, MO (US)

(21) Appl. No.: 11/465,051

(22) Filed: Aug. 16, 2006

Related U.S. Application Data
(60) Provisional application No. 60/708,947, filed on Aug. 17, 2005.
(60) Provisional application No. 60/727,324, filed on Oct. 17, 2005.

(51) Int. Cl. A23J 1/00

(52) U.S. Cl. 426/656

(57) ABSTRACT

High protein food bars having improved functionality are disclosed. Specifically, the high protein food bars comprise proteinaceous material comprising a combination of isolated soy protein and milk protein. The high protein food bars have an improved texture and extended shelf-life as compared to conventional high protein food bars.

### BACKGROUND OF THE DISCLOSURE

The present disclosure generally relates to high protein food bars comprising a proteinaceous material and processes for producing such high protein food bars. More particularly, in one embodiment, the present disclosure relates to a high protein food bar comprising a proteinaceous material comprising a combination of isolated soy protein and milk protein. In another embodiment, the proteinaceous material comprises a co-processed blend of isolated soy protein and milk protein, wherein the co-processed blend has both high molecular weight protein fractions and low molecular weight protein fractions. Both of these combinations of proteinaceous material provide for a high protein food bar having an improved texture and extended shelf-life.

In response to recent research showing the possible negative effects of particular foods, consumers are becoming more health conscious and monitoring their food intake. As a result, there is a growing popularity to utilize high protein food bars as a key component of a healthy diet. These diets have placed a major focus on providing higher levels of protein while reducing the levels of carbohydrate. The high protein food bars have to date proved to be relatively unsatisfactory and generally do not meet objectives of supplying protein without an excess of carbohydrate, due to the requirements of the manufacturing technology.

Soy protein products, because of their high protein content and low oligosaccharide/carbohydrate content, are some of the most commonly used protein ingredients for high protein food bars. Specifically, soy protein products provide a “complete” protein profile. Soybeans contain all of the amino acids essential to human nutrition, which must be supplied in the diet because they cannot be synthesized by the human body.

In addition to their high protein/low carbohydrate content, soy proteins contain no cholesterol. For decades, nutritional studies have indicated that the inclusion of soy protein in the diet actually reduces serum cholesterol levels in people who are at risk. Further, the higher the cholesterol level, the more effective soy proteins are in lowering that level.

Suitable soy protein materials for use in food bars include soy flakes, soy flour, soy grits, soy meal, soy protein concentrates, isolated soy proteins, and mixtures thereof. The primary difference between these soy protein materials is the degree of refinement relative to whole soybeans.

Soy flakes are generally produced by dehulling, defatting, and grinding the soybean and typically contain less than about 65% (by weight) soy protein on a moisture-free basis. Soy flakes also contain soluble carbohydrates, insoluble carbohydrates such as soy fiber, and fat inherent in soy. Soy flakes may be defatted, for example, by extraction with hexane. Soy flours, soy grits, and soy meals are produced from soy flakes by comminuting the flakes in grinding and milling equipment such as a hammer mill or an airjet mill to a desired particle size. The comminuted materials are typically heat treated with dry heat or steamed with moist heat to “toast” the ground flakes and inactivate anti-nutritional elements present in soy such as Bowman-Birk and Kunitz trypsin inhibitors. Heat treating the ground flakes in the presence of significant amounts of water is avoided to prevent denaturation of the soy protein in the material and to avoid costs involved in the addition and removal of water from the soy material. The resulting ground, heat treated material is a soy flour, soy grit, or a soy meal, depending on the average particle size of the material. Soy flour generally has a particle size of less than about 150 μm. Soy grits generally have a particle size of about 150 to about 1000 μm. Soy meal generally has a particle size of greater than about 1000 μm.

Soy protein concentrates typically contain from about 65% (by weight) to less than about 90% (by weight) soy protein on a moisture-free basis, with the major non-protein component being fiber. Soy protein concentrates are typically formed from defatted soy flakes by washing the flakes with either an aqueous alcohol solution or an acidic aqueous solution to remove the soluble carbohydrates from the protein and fiber.

Soy protein isolates, also referred to as isolated soy proteins, which are more highly refined soy protein materials, are processed to contain at least about 90% (by weight) soy protein on a moisture-free basis and little or no soluble carbohydrates or fiber. Isolated soy proteins are typically formed by extracting soy protein and water soluble carbohydrates from defatted soy flakes or soy flour with an alkaline aqueous extractant. The aqueous extract, along with the soluble protein and soluble carbohydrates, is separated from materials that are insoluble in the extract, mainly fiber. The extract is typically then treated with an acid to adjust the pH of the extract to the isoelectric point of the protein to precipitate the protein from the extract. The precipitated protein is separated from the extract, which retains the soluble carbohydrates, and is dried after an optional pH adjustment step.

Despite all of the above advantages, it is well known that increasing a food's protein level typically results in the loss of the desirable product texture that consumers expect. This is especially true for high protein food bars. The loss of desirable texture typically results in products, such as high protein food bars, that are described by consumers as being hard and brick like. Instead of improving texture, conventional attempts to solve textural problems merely hide unpleasant textural characteristics. Attempted solutions include coating products with materials that are high in fat. Unfortunately, these “fixes” are only temporary, as shortly after the initial bite or product breakdown, the true nature of the product's texture becomes apparent. While the loss of textural quality is appreciated by those skilled in the art, the complex interactions that give rise to poor textures are little understood.

In addition to the challenges associated with improving texture, inclusion of high levels of protein in a food bar also negatively affects the shelf-life of the food bar relative to food bars containing less protein and more carbohydrates. Many times, a high protein food bar will become hard and brick like after being on the store shelf for only a short period of time.

As such, a need exists in the industry for a high protein food bar that provides a high concentration of protein and a low concentration of carbohydrate. Additionally, it would be advantageous if the high protein food bar had an improved texture and had an extended shelf life in which it maintains its improved texture over an extended period of time.

### SUMMARY OF THE DISCLOSURE

The present disclosure is directed to high protein food bars comprising at least one type of isolated soy protein. The high protein food bars may include an isolated soy protein alone, or in combination with one or more milk proteins. Alternatively, the high protein food bars may comprise a co-processed blend of an isolated soy protein and a milk protein.

In one embodiment, the present disclosure provides high protein food bars having high protein and low carbohydrate content and processes for producing the high protein food bars. Specifically, the high protein food bars comprise proteinaceous material and carbohydrate material. In one embodiment, the proteinaceous material can comprise a blend of isolated soy proteins and milk proteins. In another embodiment, the proteinaceous material can comprise a co-processed soy protein/milk protein blend comprising isolated soy protein curds and milk proteins. The carbohydrate material comprises sugar alcohols. Other optional components may also be added. The high protein food bars provide improved texture and shelf life as compared to conventional protein-containing food bars.

In another embodiment, the present disclosure is directed to processes for making a high protein food bar. One process produces food bars containing a combination of isolated soy proteins and milk proteins. Another process of the present disclosure produces food bars containing a co-processed soy protein/milk protein blend of isolated soy protein curds and milk proteins, wherein the co-processed soy protein/milk protein blend has both high molecular weight protein fractions and low molecular weight protein fractions. The resulting food bars have improved texture and an extended shelf life as compared to conventional protein-containing food bars.

As such, the present disclosure is directed to a high protein food bar comprising from about 35% (by total weight food bar) to about 55% (by total weight food bar) proteinaceous material and from about 35% (by total weight food bar) to about 50% (by total weight food bar) carbohydrate material. The proteinaceous material comprises a combination of an isolated soy protein and a milk protein. Additionally, the isolated soy protein has a soluble solids index of greater than about 70% and has a degree of hydrolysis of from about 75 STNBS to about 125 STNBS. The carbohydrate material comprises one or more sugar alcohols and a bulking agent. The resulting high protein food bar has a mechanical hardness of less than 2500 grams force.

The present disclosure is further directed to a high protein food bar comprising from about 35% (by total weight food bar) to about 55% (by total weight food bar) proteinaceous material and from about 35% (by total weight food bar) to about 50% (by total weight food bar) carbohydrate material. The proteinaceous material comprises a combination of a first isolated soy protein, a second isolated soy protein, and a milk protein. Additionally, the first isolated soy protein has a soluble solids index of greater than about 70% and has a degree of hydrolysis of from about 75 STNBS to about 125 STNBS. The second isolated soy protein has a soluble solids index of from about 30% to about 60% and has a degree of hydrolysis of from about 25 STNBS to about 35 STNBS. The carbohydrate material comprises one or more sugar alcohols and a bulking agent. The resulting high protein food bar has a mechanical hardness of less than 2500 grams force.

The present disclosure is further directed to a process for producing a high protein food bar, the process comprising: combining a proteinaceous material and a carbohydrate material to form a dough; sheeting out the dough; and dividing the dough into individual high protein food bars. The proteinaceous material comprises from about 33% (by total weight proteinaceous material) to about 75% (by total weight proteinaceous material) isolated soy protein and from about 25% (by total weight proteinaceous material) to about 67% (by total weight proteinaceous material) milk protein. Additionally, the isolated soy protein has a soluble solids index of greater than about 70% and has a degree of hydrolysis of from about 75 STNBS to about 125 STNBS. The carbohydrate material comprises one or more sugar alcohols and a bulking agent.

The present disclosure is further directed to a high protein food bar comprising from about 35% (by total weight food bar) to about 55% (by total weight food bar) proteinaceous material, and from about 35% (by total weight food bar) to about 50% (by total weight food bar) carbohydrate material. The proteinaceous material comprises a combination of an isolated soy protein and a milk protein, wherein the isolated soy protein has a soluble solids index of from about 30% to about 45% and has a degree of hydrolysis of from about 40 STNBS to about 55 STNBS. The carbohydrate material comprises one or more sugar alcohols and a bulking agent. The high protein food bar has a mechanical hardness of less than about 2500 grams force.

The present disclosure is further directed to a high protein food bar comprising from about 35% (by total weight food bar) to about 55% (by total weight food bar) proteinaceous material and from about 35% (by total weight food bar) to about 50% (by total weight food bar) carbohydrate material. The proteinaceous material comprises a co-processed soy protein/milk protein blend having a soluble solids index of from about 30% to about 60% and a degree of hydrolysis of from about 45 STNBS to about 65 STNBS. The carbohydrate material comprises one or more sugar alcohols and a bulking agent. The resulting high protein food bar has a mechanical hardness of less than 2500 grams force.

The present disclosure is further directed to a process of producing the high protein food bar, the process comprising: combining a proteinaceous material and a carbohydrate material to form a dough; sheeting out the dough; and dividing the dough into individual high protein food bars. The proteinaceous material comprises from about 10% (by total weight proteinaceous material) to about 90% (by total weight proteinaceous material) isolated soy protein and from about 10% (by total weight proteinaceous material) to about 90% (by total weight proteinaceous material) milk protein. Additionally, the isolated soy protein has a soluble solids index of from about 30% to about 45% and has a degree of hydrolysis of from about 40 STNBS to about 55 STNBS. The carbohydrate material comprises one or more sugar alcohols and a bulking agent.

The present disclosure is further directed to a process of producing the high protein food bar, the process comprising: combining a proteinaceous material and a carbohydrate material to form a dough; sheeting out the dough; and dividing the dough into individual high protein food bars. The proteinaceous material comprises a co-processed soy protein/milk protein blend having a soluble solids index of from about 30% to about 60% and has a degree of hydrolysis of from about 45 STNBS to about 65 STNBS. The carbohydrate material comprises one or more sugar alcohols and a bulking agent.

Other features and advantages of this disclosure will be in part apparent and in part pointed out hereinafter.

### DETAILED DESCRIPTION OF THE PREFERRED EMBODIMENTS

The present disclosure is generally directed to high protein food bars and processes for producing the high protein food bars. As used herein, “high protein food bars” means a food bar having at least about 25% (by weight food bar) proteinaceous material. In one embodiment, the high protein food bars provide high levels of protein, while providing a reduced level of carbohydrate. Surprisingly, it has been discovered that by utilizing specific isolated soy proteins and/or milk proteins an improved high protein/low carbohydrate food bar can be produced. The high protein food bars have an improved texture and extended shelf life compared to conventional protein-containing food bars.

In one embodiment, the high protein food bar comprises from about 35% (by total weight food bar) to about 55% (by total weight food bar) proteinaceous material and from about 35% (by total weight food bar) to about 50% (by total weight food bar) carbohydrate material. The proteinaceous material comprises isolated soy protein and milk protein. Suitably, the proteinaceous material comprises from about 10% (by total weight proteinaceous material) to about 90% (by total weight proteinaceous material) isolated soy protein and from about 10% (by total weight proteinaceous material) to about 90% (by total weight proteinaceous material) milk protein. More suitably, the proteinaceous material comprises from about 33% (by total weight proteinaceous material) to about 75% (by total weight proteinaceous material) isolated soy protein and from about 25% (by total weight proteinaceous material) to about 67% (by total weight proteinaceous material) milk protein, and even more suitably, about 50% (by total weight proteinaceous material) isolated soy protein and about 50% (by total weight proteinaceous material) milk protein.

In another embodiment, the high protein food bar comprises from about 25% (by total weight food bar) to about 50% (by total weight food bar) proteinaceous material and from about 40% (by total weight food bar) to about 55% (by total weight food bar) carbohydrate material. Similar to the above embodiment, the proteinaceous material is comprised of isolated soy proteins and milk proteins. Suitably, the proteinaceous material comprises from about 10% (by total weight proteinaceous material) to about 90% (by total weight proteinaceous material) isolated soy protein and from about 10% (by total weight proteinaceous material) to about 90% (by total weight proteinaceous material) milk protein. More suitably, the proteinaceous material comprises from about 33% (by total weight proteinaceous material) to about 75% (by total weight proteinaceous material) isolated soy protein and from about 25% (by total weight proteinaceous material) to about 67% (by total weight proteinaceous material) milk protein, and even more suitably, about 50% (by total weight proteinaceous material) isolated soy protein and about 50% (by total weight proteinaceous material) milk protein.

In yet another embodiment, the high protein food bar comprises from about 25% (by total weight food bar) to about 50% (by total weight food bar) proteinaceous material and from about 40% (by total weigh food bar) to about 55% (by total weight food bar) carbohydrate material. In this embodiment, the proteinaceous material comprises about 100% (by total weight proteinaceous material) isolated soy protein.

In another embodiment, the high protein food bar comprises from about 25% (by total weight food bar) to about 50% (by total weight food bar) proteinaceous material and from about 40% (by total weight food bar) to about 55% (by total weight food bar) carbohydrate material. The proteinaceous material of this embodiment comprises about 100% (by total weight proteinaceous material) co-processed soy protein/milk protein blend.

In still another embodiment, the high protein food bar comprises from about 35% (by total weight food bar) to about 55% (by total weight food bar) proteinaceous material and from about 35% (by total weight food bar) to about 50% (by total weight food bar) carbohydrate material. In this embodiment, the proteinaceous material comprises about 100% (by total weight proteinaceous material) co-processed soy protein/milk protein blend.

Manufacture of Isolated Soy Proteins for Use in Food Bars

Isolated soy proteins suitable for use in the proteinaceous material of the high protein food bars described herein can be prepared by one skilled in the art based on the disclosure herein. Additionally, as discussed in more detail below, a number of commercially available isolated soy proteins may be used in the food bars described herein.

In one embodiment, the proteinaceous material of the high protein food bar comprises one isolated soy protein in combination with a milk protein. In another embodiment, the proteinaceous material of the high protein food bars comprises a first isolated soy protein and a second isolated soy protein in combination with milk protein. In the embodiment comprising a first isolated soy protein and a second isolated soy protein, the first isolated soy protein and second isolated soy protein are present in the proteinaceous material in a weight ratio of first isolated soy protein to second isolated soy protein of from about 1.5:1 to about 1:1.5, more suitably of about 1:1.

In another embodiment, the proteinaceous material of the high protein food bar comprises one isolated soy protein having both high molecular weight protein fractions and low molecular weight protein fractions. In another embodiment, the proteinaceous material of the high protein food bar comprises one isolated soy protein having both high molecular weight protein fractions and low molecular weight protein fractions in combination with milk protein. As used herein, when an isolated soy protein has a “high molecular weight protein fraction,” the isolated soy protein has a protein fraction having a molecular weight of greater than about 30,000 Daltons. When an isolated soy protein has a “low molecular weight protein fraction,” the isolated soy protein has a protein fraction having a molecular weight of less than about 10,000 Daltons.

In another embodiment, the proteinaceous material of the high protein food bars comprises a co-processed soy protein/milk protein blend of an isolated soy protein and milk protein. The co-processed soy protein/milk protein blend has both high molecular weight protein fractions and low molecular weight protein fractions. As used herein, when a co-processed soy protein/milk protein blend of isolated soy protein and milk protein has a “high molecular weight protein fraction,” the co-processed soy protein/milk protein blend has a protein fraction having a molecular weight of greater than about 25,000 Daltons. When a co-processed soy protein/milk protein blend of isolated soy protein and milk protein has a “low molecular weight protein fraction,” the co-processed soy protein/milk protein blend has a protein fraction having a molecular weight of less than about 7,000 Daltons.

A suitable process for manufacturing an isolated soy protein suitable for use in the high protein food bars described herein includes precipitating a soy protein curd, diluting the soy protein curd with water to form a soy protein slurry, adjusting the pH of the soy protein slurry, and heating and drying the soy protein slurry to form dried isolated soy proteins. More specifically, the process for producing the precipitated soy protein curd begins by producing white flakes from whole soybeans. Generally, the conventional process for producing white flakes from whole soybeans comprises: 1) dehulling whole soybeans; 2) flaking the dehulled soybeans; 3) extracting soybean oil from the flaked soybeans with a solvent such as hexane; and 4) desolventizing the defatted soybeans without high heating or toasting to produce white flakes. The white flakes can also optionally be ground to produce soy flour. For purposes of the present disclosure, it is contemplated that the term “white flakes” includes soy flour, since soy flour is merely ground white flakes. It is further contemplated that the whole soybeans used in the process of the present disclosure may be standard, commoditized soybeans, soybeans that have been genetically modified (GM) in some manner, or non-GM identity preserved soybeans.

White flakes produced from soybeans by the above-described steps are utilized as the starting material in the precipitated soy protein curd formation process. Soy protein is extracted from the white flakes by dispersing them in a liquid. In one embodiment of the present disclosure, the soy protein is extracted from the white flakes by dispersing them in water at a pH of from about 6.4 to about 7.5. Preferably, the soy protein is extracted from the white flakes by dispersing them in water at a pH of from about 6.4 to about 6.8; more preferably, the water is at a pH of about 6.7. In an alternative embodiment of the present disclosure, the soy protein is extracted from the white flakes by dispersing them in an alkaline solution at a pH of from about 9.5 to about 10.0. Preferably, the soy protein is extracted from the white flakes by dispersing them in an alkaline solution at a pH of from about 9.6 to about 9.8; more preferably, the alkaline solution is at a pH of about 9.7. Preferably, the alkaline solution comprises an alkaline material selected from the group consisting of sodium hydroxide, calcium hydroxide, and mixtures thereof. The soluble soy protein extract found in the liquid is preferably separated from the insoluble material, such as soy fiber and cellulose, by filtration and/or by centrifuging the soy protein extract and decanting the soluble soy protein extract from the undesirable insoluble material.

A suitable acid is then added to the soluble soy protein extract to adjust the pH to about the isoelectric point of soy protein to precipitate the soy protein, forming a precipitated soy protein curd mixture. Preferably, the pH of the soluble soy protein extract is adjusted to a pH of from about 4.0 to about 5.0; more preferably to a pH of from about 4.4 to about 4.6. Preferably, the pH is adjusted with hydrochloric acid, citric acid, phosphoric acid, or mixtures thereof. The precipitated soy protein curd mixture is then centrifuged, and the supernatant is decanted and discarded. The remaining material is the precipitated soy protein curd.

The above extraction, suspension, and precipitation steps can optionally be repeated one or more times to further remove impurities, such as carbohydrates and fat, from the precipitated soy protein curd. Other suitable extraction processes for forming soy protein curds for use in the present disclosure are well known and disclosed, for example, in U.S. Pat. No. 6,313,273, issued to Thomas, et al. (Nov. 6, 2001) and U.S. Pat. No. 6,830,773, issued to Porter, et al. (Dec. 14, 2004).

After producing the precipitated soy protein curd, the precipitated soy protein curd is diluted with water to form a soy protein curd slurry. Preferably, the precipitated soy protein curd is diluted with water to produce a soy protein curd slurry that is from about 12% to about 20% solids, by weight. Still more preferably, the soy protein curd slurry is from about 14% to about 18% solids, by weight. Most preferably, the soy protein curd slurry is from about 15% to about 17% solids, by weight.

In one embodiment of the present disclosure, an isolated soy protein referred to herein as Isolated Soy Protein (ISP) 1 may be used as an isolated soy protein in the high protein food bar. To produce ISP 1, the above-described soy protein curd slurry is first neutralized to a pH of from about 7.2 to about 7.6 with an aqueous alkaline solution or an aqueous alkaline earth solution, preferably a sodium hydroxide solution or a potassium hydroxide solution. The neutralized soy protein curd is then optionally heated.

The heat treatment acts to sterilize or pasteurize the soy protein product to reduce bacterial growth. One suitable method for heating the neutralized soy protein curd is by jet cooking. As used herein, “jet-cooking” refers to the method of heating a soy protein curd material at a temperature elevated above ambient temperatures by injecting pressurized steam into the curd material. In one embodiment, the neutralized soy protein curd is introduced into a suitable jet-cooker feed tank where the neutralized soy protein curd is held in suspension and mixed using a conventional mixer. The neutralized soy protein curd slurry is then directed from the feed tank to a pump which forces the neutralized soy protein curd slurry through a reactor tube. Steam is injected into the neutralized soy protein curd slurry under a suitable pressure as the neutralized soy protein curd slurry enters the reactor tube, instantly heating the curd to a desired temperature. The temperature is controlled by adjusting the pressure of the injected steam. Suitably the temperature is from about 75° C. to about 160° C., more preferably from about 100° C. to about 155° C. The neutralized soy protein curd slurry is treated at the elevated temperature for a treatment time being controlled by the flow rate of the neutralized soy protein curd slurry through the tube. Suitably, the treatment time is a period of from about 5 to about 15 seconds, more suitably, for a period of from about 7 to about 12 seconds, and even more suitably, about 9 seconds.

The heated neutralized soy protein curd slurry may then be cooled in any conventional manner known in the art. One suitable method for cooling the heated neutralized soy protein curd is by flash vaporization. In one embodiment, the heated neutralized soy protein curd slurry is flash vaporized by introducing the hot curd into a vacuumized chamber having an internal temperature of from about 50° C. to about 60° C., which instantly drops the pressure around the neutralized soy protein curd slurry to a pressure of from about 57 mmHg to about 73 mmHg. Additionally, this flash vaporization drops the temperature of the neutralized soy protein curd slurry to a temperature of from about 50° C. to about 60° C.

The cooled neutralized soy protein curd slurry is then treated with an enzyme that is effective in hydrolyzing the soy protein in the cooled neutralized soy protein curd slurry. The long chain peptides of the soy protein material of the pH-adjusted soy protein curd slurry are broken down by peptide hydrolysis. The degree of hydrolysis is determined by the Simplified Trinitrobenzene Sulfonic acid (STNBS) method, described herein below.

Suitably, the cooled neutralized soy protein curd slurry is reacted with an enzyme at a temperature and a time to produce a soy protein material having a degree of hydrolysis of from about 75 STNBS to about 95 STNBS. More suitably, the neutralized soy protein curd slurry is reacted with an enzyme at a temperature and a time to produce a soy protein material having a degree of hydrolysis of from about 80 STNBS to about 90 STNBS. Suitably, the cooled neutralized soy protein curd slurry is reacted with an enzyme at a temperature of from about 40° C. to about 65° C., more suitably at a temperature of about 60° C., and for a time period of from about 10 minutes to about 65 minutes, more suitably from about 20 minutes to about 45 minutes. One suitable enzyme to effect protein hydrolysis is bromelain.

The amount of the enzyme added for the enzyme treatment of the pH-adjusted soy protein curd slurry depends on the weight of the soy protein curd slurry prior to pH adjustment. Typically, the enzyme is reacted with the neutralized soy protein curd slurry at a concentration of from about 0.8% (by weight dry neutralized soy protein curd) to about 2% (by weight dry neutralized soy protein curd) enzyme.

The hydrolysis is then terminated by subjecting the hydrolyzed soy protein material to a second heat treatment, heating the hydrolyzed soy protein material to a temperature effective to inactivate the enzyme. Typically, the hydrolyzed soy protein material is heated to an elevated temperature, under a positive pressure greater than atmospheric pressure. Suitably, the hydrolyzed soy protein material is heated to a temperature of from about 75° C. to about 160° C. for a time period of from about 2 seconds to about 2 hours, wherein the hydrolyzed soy protein material is heated for a longer time period at a lower temperature or a shorter time period at a higher temperature.

After the second heat treatment, the heated hydrolyzed soy protein material may then be subjected to a second cooling treatment. In one embodiment, the hydrolyzed soy protein material is jet cooked to inactivate the enzyme and then flash cooled as described above to produce a slurry of ISP 1.

The ISP 1 slurry may then be dried using any conventional manner known in the art. One suitable method of drying is spray drying. Typically, spray drying is conducted using a co-current flow dryer where hot inlet air and ISP 1 slurry pass through the dryer in a co-current flow after being injected under pressure into the dryer through an atomizer. Suitable atomizers include nozzle atomizers and rotary atomizer. Suitably, the ISP 1 slurry is injected into the dryer through a nozzle atomizer under a pressure of about 3000 psig to about 5500 psig. More suitably, the ISP I slurry is injected into the dryer through a nozzle atomizer under a pressure of about 3500 psig to about 5000 psig. The hot air, which, as noted above, flows co-currently with the atomized ISP I slurry, suitably has a temperature of from about 285° C. to about 315° C., and more suitably from about 290° C. to about 300° C.

The dried ISP 1 is collected from the spray dryer using any conventional manner known in the art, and may be used in the high protein food bars of the present disclosure. Suitable collection means can include, for example, cyclones, bag filters, electrostatic precipitators, and gravity collection.

Typically, ISP 1 comprises at least about 90% (by weight dry isolate) protein, and more suitably at least about 92% (by weight dry isolate) protein. ISP 1 is highly soluble in water and has a soluble solids index as described below of at least about 70%, and suitably of at least about 80%. Additionally, ISP 1 has a degree of hydrolysis as described below of from about 75 STNBS to about 95 STNBS, and suitably of from about 80 STNBS to about 90 STNBS.

In another embodiment, an isolated soy protein referred to herein as Isolated Soy Protein (ISP) 2 may be used as an isolated soy protein in the high protein food bar. To produce ISP 2, the pH of the soy protein curd slurry described above is adjusted to a pH of from about 9.5 to about 10.5, more suitably to a pH of from about 9.8 to about 10.2, and even more suitably to a pH of about 10.0 using a suitable base. Suitable bases for neutralizing the soy protein curd in this embodiment can include, for example, sodium hydroxide, potassium hydroxide, and mixtures thereof A particularly preferred base is sodium hydroxide.

The pH-adjusted soy protein curd slurry is then subjected to a heat treatment. Suitable heat treatments can include direct steam heating and indirect steam heating. Suitably, the pH-adjusted soy protein curd slurry is heated to a temperature of from about 48° C. to about 58° C. (118-136° F.), more suitably the pH-adjusted soy protein curd slurry is heated to a temperature of from about 48° C. to about 55° C. (118.4-131° F.), and even more suitably to a temperature of from about 51° C. to about 53° C. (124-127° F.).

Once the pH-adjusted soy protein curd slurry is heated, the heated pH-adjusted soy protein curd slurry is held at the heated temperature during an enzyme treatment. Holding the heated pH-adjusted soy protein curd slurry at the heated temperature provides for a more effective enzyme-induced hydrolysis reaction. The enzyme hydrolysis of the pH-adjusted soy protein curd slurry facilitates two reactions. In one reaction, the long chain peptides of the soy protein material of the pH-adjusted soy protein curd slurry are broken down by peptide hydrolysis. The other reaction is a deamidate reaction between amide groups (—NH₃) of glutamines and hydroxide groups in the pH-adjusted soy protein curd slurry.

One suitable enzyme is an alkaline protease enzyme. Suitable alkaline protease enzymes for use in the enzyme treatment can include, for example, Alcalase® (available from Novo Nordisk A/S, Denmark), Alkaline Protease Concentrate (available from Valley Research, South Bend, Ind.), and Protex™6L (available from Genencor, Palo Alto, Calif.).

The amount of enzyme added for the enzyme treatment of the pH-adjusted soy protein curd slurry depends on the weight of the soy protein curd slurry prior to pH adjustment. Specifically, the amount of the enzyme added to the pH-adjusted soy protein curd slurry is from about 1.5% (by weight soy protein curd slurry) to about 2.5% (by weight soy protein curd slurry).

The time period required for effective enzyme hydrolysis of the soy protein material of the pH-adjusted soy protein curd slurry is typically from about 30 minutes to about 60 minutes. More suitably, the enzyme treatment of the pH-adjusted soy protein curd slurry is for a time period of from about 30 minutes to about 50 minutes, and even more suitably, from about 35 minutes to about 45 minutes.

Typically, the enzyme treatment is conducted in a two hydrolysis tank system. In the first hydrolysis tank, the pH of the pH-adjusted soy protein curd slurry is maintained at a pH of about 9.8 to about 10.2 using 10% sodium hydroxide to facilitate enzyme hydrolysis of the soy protein material. After enzyme hydrolysis, the enzyme hydrolyzed soy protein curd slurry is moved to the second hydrolysis tank, in which the pH of the enzyme hydrolyzed soy protein curd slurry is adjusted to a pH of from about 7.2 to about 7.6 using a suitable organic or inorganic acid. More suitably, the pH of the enzyme hydrolyzed soy protein curd slurry is adjusted to about 7.4. Suitable acids for pH adjustment of the enzyme hydrolyzed soy protein curd slurry include hydrochloric acid, phosphoric acid, and mixtures thereof. The lowered pH of the enzyme hydrolyzed soy protein curd slurry provides for an isolated soy protein (ISP 2) having improved functional characteristics for use in the high protein food bars of the present disclosure.

Optionally, the enzyme hydrolyzed soy protein curd slurry can be heated, cooled, and dried to form a dry ISP 2 product. The optional heat treatment acts to sterilize or pasteurize the product to reduce bacterial growth. In one embodiment, the enzyme hydrolyzed soy protein curd slurry is heated using the method of jet-cooking as described in the process for making ISP 1 above. Suitably, the enzyme hydrolyzed soy protein curd slurry is heated to a temperature of from about 146° C. to about 157° C. for a period of from about 5 seconds to about 15 seconds. More suitably, the enzyme hydrolyzed soy protein curd slurry is heated to a temperature of from about 149° C. to about 154° C. for a period of from about 7 seconds to about 12 seconds, and even more suitably, heated to a temperature of from about 150° C. to about 153° C. for a period of from about 8 seconds to about 10 seconds.

Following the heat treatment, the heated enzyme hydrolyzed soy protein curd slurry can then optionally by cooled by any suitable method know in the art. In one embodiment, the heated enzyme hydrolyzed soy protein curd slurry is cooled by vacuum flushing to a temperature of from about 48° C. to about 58° C. More suitably, the heated enzyme hydrolyzed soy protein curd slurry is cooled to a temperature of from about 49° C. to about 55° C., and even more suitably, cooled to a temperature of from about 51° C. to about 53° C.

Additionally, as noted above, the enzyme hydrolyzed soy protein curd slurry can be dried. Suitably the enzyme hydrolyzed soy protein curd slurry is dried by spray drying in the manner as described for ISP 1 above.

ISP 2 made by the above process typically comprises at least about 90% (by weight dry isolate) protein, and more suitably, at least about 92% (by weight dry isolate) protein. ISP 2 is highly soluble in water and has a soluble solids index as described below of at least about 80%, and more suitably at least about 90%. Additionally, ISP 2 has a degree of hydrolysis as described below of from about 100 STNBS to about 125 STNBS, and more suitably of from about 105 STNBS to about 120 STNBS.

In another embodiment, an isolated soy protein referred to herein as Isolated Soy Protein (ISP) 3 may be utilized as an isolated soy protein in the proteinaceous material of the high protein food bar. To produce ISP 3, the soy protein curd slurry described above is first neutralized to a pH of from about 6.8 to about 7.2 using an aqueous alkaline solution or an aqueous alkaline earth solution. Suitable aqueous alkaline solutions can include sodium hydroxide solutions or potassium hydroxide solutions.

The neutralized soy protein curd slurry is then heat treated, cooled, and dried. Suitably, the neutralized soy protein curd slurry is heated using the method of jet-cooking as described in the process for making ISP 1 and ISP 2 above. After the heat treatment, the heated neutralized soy protein curd slurry is cooled by the method of flash vaporization described above to a temperature of from about 70° C. to about 85° C. Finally, the cooled neutralized soy protein curd slurry is dried using spray drying in the manner as described for ISP 1 and ISP 2 above to produce ISP 3.

Typically, ISP 3 produced according to the above process comprises at least about 90% (by weight dry isolate) protein, and more suitably at least about 92% (by weight dry isolate) protein. ISP 3 is an intact protein. As used herein, an “intact” protein is a protein which has not been hydrolyzed by enzyme treatment, heat treatment, or treatment with an acid or alkali. Additionally, ISP 3 is not highly soluble in water. Typically, ISP 3 has a soluble solids index as described below of from about 35% to about 60%, more suitably from about 40% to about 50%. Additionally, ISP 3 has a degree of hydrolysis as described below of from about 25 STNBS to about 35 STNBS.

Typically, the isolated soy proteins described above have large particles, and provide for high protein food bars with a softer texture. The dried ISP 3 has a larger particle size as compared to ISP 1 and ISP 2. Specifically, ISP 3 has a particle size of from about 40 microns to about 65 microns. As such, ISP 3 may optionally be ground using any conventional powder grinding process known in the art.

In yet another embodiment, an isolated soy protein, having both high molecular weight protein fractions and low molecular weight protein fractions, referred to herein as Isolated Soy Protein (ISP) 4 may be utilized as an isolated soy protein in the proteinaceous material. To produce ISP 4, the soy protein curd slurry described above is first neutralized to a pH of from about 5.8 to about 6.6 using an aqueous alkaline solution or an aqueous alkaline earth solution. Suitable aqueous alkaline solutions can include sodium hydroxide solutions or potassium hydroxide solutions.

The neutralized soy protein curd slurry is then heated to a temperature of from about 50° C. to about 60° C., more suitably about 54° C. by direct or indirect steam injection. The heated neutralized soy protein curd slurry is then treated with an enzyme that is effective in hydrolyzing the soy protein in the heated neutralized soy protein curd slurry. Suitably, the heated neutralized soy protein curd slurry is reacted with an enzyme at a temperature and a time period to produce a soy protein material having a degree of hydrolysis of from about 40 STNBS to about 55 STNBS. More suitably, the heated neutralized soy protein curd slurry is reacted with an enzyme at a temperature and a time to produce a soy protein material having a degree of hydrolysis of about 45 STNBS. Suitably, the heated neutralized soy protein curd slurry is reacted with an enzyme at a temperature of from about 50° C. to about 60° C., more suitably a temperature of about 54° C., and for a time period of from about 20 minutes to about 60 minutes, more suitably from about 30 minutes to about 60 minutes, and even more suitably for about 35 minutes.

Suitable enzymes for reacting with the heated neutralized soy protein curd include neutral protease enzymes such as, for example, bromelain or any other enzyme having proteolytic activity at a pH of from about 4.5 to about 8.0. Suitable enzymes are known to those skilled in the art and are commercially available from numerous vendors such as, for example, Novozymes (Denmark), Valley Research (South Bend, Ind.), and Genencor (Palo Alto, Calif.). In a particularly preferred embodiment, the enzyme is bromelain having an activity of 2500 BTU/gram.

The amount of the enzyme added for the enzyme treatment depends on the weight of the neutralized soy protein curd slurry. Typically, the enzyme is reacted with the heated neutralized soy protein curd slurry at a concentration of from about 0.10% (by weight dry neutralized soy protein curd) to about 0.20% (by weight dry neutralized soy protein curd), suitably about 0.15% (by weight dry neutralized soy protein curd).

The hydrolysis is then terminated by subjecting the enzyme treated soy protein material to a second heat treatment, heating the enzyme treated soy protein material to a temperature effective to inactivate the enzyme. Typically, the enzyme treated soy protein material is heated to a temperature of from about 125° C. to about 160° C. for a time period of from about 5 seconds to about 30 seconds. More suitably, the enzyme treated soy protein material is heated to a temperature of about 152° C. for a time period of about 9 seconds.

After the second heat treatment, the heated enzyme treated soy protein material may be cooled by the method of flash vaporization described above to a temperature of less than about 90° C., more suitably to a temperature of about 82° C. Finally, the cooled enzyme treated soy protein material is dried using spray drying in the manner as described for ISP 1 and ISP 2 above to produce ISP 4.

Typically, ISP 4 produced according to the above process comprises at least about 90% (by weight dry isolate) protein, and more suitably at least about 92% (by weight dry isolate) protein. Additionally, ISP 4-type soy protein isolate typically has a soluble solids index as described below of from about 30% to about 45%, more suitably from about 30% to about 40%, and even more suitably about 35%.

Additionally, the above hydrolysis of the ISP 4-type soy protein isolate is conducted under conditions for maintaining the protein in its native globular state. Under these conditions, the protein hydrolysis occurs on the outside of the molecule producing low molecular weight protein fractions while maintaining high molecular weight protein fractions inside of the molecule. As such, ISP 4-type soy protein isolates contain both high molecular weight protein fractions and low molecular weight protein fractions. As described more fully below, by having both the high molecular weight protein fractions and low molecular weight protein fractions, the ISP 4-type soy protein isolate can be used as a single protein source for providing a soft, short textured food product.

As noted above, commercially available isolated soy proteins may be used in the high protein food bars described herein. Two examples of suitable commercially available ISP 1-type isolated soy proteins are FXP H0313 and Supro® Plus 1764, both of which are available from The Solae® Company (St. Louis, Mo.). One example of a suitable commercially available ISP 2-type isolated soy protein is FXP 950, available from The Solae Company (St. Louis, Mo.). Suitable examples of commercially available ISP 3-type isolated soy proteins include FXP H0320, FXP H0298, Supro® 660, and Supro® 1610, all available from The Solae Company (St. Louis, Mo.).

In addition to the protein content in the isolated soy proteins, the isolated soy proteins (in dry basis) generally comprise less than about 0.5% (by weight dry isolate) carbohydrates including fibers, from about 3.5% (by weight dry isolate) to about 6.0% (by weight dry isolate) fat, and from about 3.5% (by weight dry isolate) to about 7.0% (by weight dry isolate) ash.

In another embodiment, isolated soy proteins and milk proteins are mixed to form a protein mixture that may be co-processed to form a co-processed soy protein/milk protein blend for use as the proteinaceous material. Specifically, in one suitable embodiment for producing the co-processed soy protein/milk protein blend, isolated soy protein, which is produced in the processes described above for making ISP 1-type, ISP 2-type, ISP 3-type, or ISP 4-type isolated soy proteins, and milk proteins, such as described below, are mixed to form a protein mixture. The amount of isolated soy protein and milk protein used to produce the co-processed soy protein/milk protein blend will depend on the type of milk protein used and the targeted high protein food bar application. Typically, the protein mixture includes from about 10% (by total weight protein mixture) to about 90% (by total weight protein mixture) isolated soy protein and from about 10% (by total weight protein mixture) to about 90% (by total weight protein mixture) milk protein. More suitably, the protein mixture includes about 50% (by total weight protein mixture) isolated soy protein and about 50% (by total weight protein mixture) milk protein.

The protein mixture is then adjusted to a pH of from about 6.0 to about 6.5 with an aqueous alkaline solution comprising sodium hydroxide or potassium hydroxide and then heated using direct or indirect steam injection to a temperature of from about 50° C. to about 60° C. More suitably, the protein mixture is heated to a temperature of about 54° C.

The heated protein mixture is then treated with an enzyme for a period of from about 20 minutes to about 60 minutes to form an enzyme treated protein mixture. More suitably, the heated protein mixture is reacted with an enzyme for a time period of from about 30 minutes to about 60 minutes, and even more suitably for about 35 minutes.

Suitable enzymes for reacting with the heated protein mixture include protease enzymes such as, for example, bromelain or any other enzyme having proteolytic activity at a pH of from about 4.5 to about 8.0. Suitable enzymes are known to those skilled in the art and are commercially available from numerous vendors such as, for example, Novozymes (Denmark), Valley Research (South Bend, Ind.), and Genencor (Palo Alto, Calif.). In a particularly preferred embodiment, the enzyme is bromelain having an activity of 2500 BTU/gram.

The amount of the enzyme added for the enzyme treatment depends on the weight of the protein mixture. Typically, the enzyme is reacted with the heated protein mixture at a concentration of from about 0.10% (by weight dry protein mixture) to about 0.20% (by weight dry protein mixture), suitably about 0.15% (by weight dry protein mixture).

The hydrolysis is then terminated by subjecting the enzyme treated protein mixture to a second heat treatment, heating the enzyme treated protein mixture to a temperature effective to inactivate the enzyme. Typically, the enzyme treated protein mixture is heated to a temperature of from about 125° C. to about 160° C. for a time period of from about 5 seconds to about 30 seconds. More suitably, the enzyme treated protein mixture is heated to a temperature of about 152° C. for a time period of about 9 seconds.

Optionally, after the second heat treatment, the heated enzyme treated protein mixture may be cooled by the method of flash vaporization described above to a temperature of less than about 90° C., more suitably to a temperature of about 82° C. Finally, the cooled enzyme treated protein mixture is optionally dried using spray drying in the manner as described above.

Isolated Soy Protein Characteristics

The ISP 1-type and ISP 2-type isolated soy proteins contained in the high protein food bars of the present disclosure have a high degree of hydrolysis. Isolated soy proteins that have a high degree of hydrolysis typically have a lower average molecular weight. Typically, an isolated soy protein with a high degree of hydrolysis provides an improved binding property with the other ingredients in the high protein food bar. This improved binding allows for improved dispersiblity, reduced viscosity, and lower water holding capacity of the resulting high protein food bars.

The ISP 3-type isolated soy protein has a lower degree of hydrolysis compared to the ISP 1-type, ISP 2-type, and ISP 4-type isolated soy proteins. Typically, an isolated soy protein with a lower degree of hydrolysis provides structure in the high protein food bar. This structure forming protein provides high protein food bars with a harder, chewier texture as described below.

The ISP 4-type isolated soy protein is hydrolyzed under process conditions to produce both high molecular weight protein fractions and low molecular weight protein fractions. The high molecular weight protein fractions function as structure proteins, providing a short texture, while the low molecular weight protein fractions function as binding proteins, providing high solubility at low pH levels and low viscosity. The overall process produces an isolated soy protein providing a soft, short texture in food products such as high protein food bars.

As noted above, one method for determining the degree of hydrolysis for highly hydrolyzed isolated soy protein is by using the Simplified Trinitrobenzene Sulfonic acid (STNBS) method.

Primary amines exist in protein material as amino terminal groups and as the amino group of lysyl residues. The process of enzymatic hydrolysis cleaves the peptide chain structure of an isolated soy protein material, creating one new amino terminal group with each new break in the chain. Trinitrobenzene sulfonic acid (TNBS) reacts with these primary amines to produce a chromophore which absorbs light at 420 nm. The intensity of color developed from the TNBS-amine reaction is proportional to the total number of amino terminal groups and, therefore, is an indicator of the degree of hydrolysis of an isolated soy protein sample.

Specifically, to determine the degree of hydrolysis of an isolated soy protein sample, 0.1 grams of the isolated soy protein is added to 100 milliliters 0.025N NaOH. The sample mixture is stirred for 10 minutes and is filtered through Whatman No. 4 filter paper. A 2-milliliter portion of the sample mixture is then diluted to 10 milliliters with 0.05M sodium borate buffer (pH 9.5). A 2-milliliter blank of 0.025N NaOH is also diluted to 10 milliliters with 0.05M sodium borate buffer (pH 9.5). Aliquots (2 milliliters) of the sample mixture and the blank (2 milliliters) are then placed in separate test tubes. Duplicate 2-milliliter samples of glycine standard solution (0.005M) are also placed in separate test tubes. Then, 0.3M TNBS (0.1-0.2 milliliters) is added to each test tube and the tubes are vortexed for 5 seconds. The TNBS is allowed to react with each proteinaceous sample, blank, and standard for 15 minutes. The reaction is terminated by adding 4 milliliters of phosphate-sulfite solution (1% 0.1M Na₂SO₃, 99% 0.1M NaH₂PO₄.H₂O) to each test tube with vortexing for 5 seconds. The absorbance of all samples, blanks, and standards are recorded against deionized water within 20 minutes of the addition of the phosphate-sulfite solution.

The STNBS value, which is a measure of NH₂ moles/10⁵ grams protein, is then calculated using the following formula:
STNBS=(As₄₂₀−Ab₄₂₀)×(8.073)×(1/W)×(F)(100/P)
wherein As₄₂₀ is the TNBS absorbance of the sample solution at 420 nm; Ab₄₂₀ is the TNBS absorbance of the blank at 420 nm; 8.073 is the extinction coefficient and dilution/unit conversion factor in the procedure; W is the weight of the isolated soy protein sample; F is a dilution factor; and P is the percent protein content of the sample, measured using the Kjeldahl, Kjel-Foss, or LECO combustion procedures. Typically, when using an ISP 2-type isolated soy protein, the dilution factor is two. When using either an ISP 1-type, ISP 3-type, or ISP 4-type isolated soy protein, the dilution factor is one.

Suitably, in one embodiment, the carbohydrate material of the high protein food bar comprises one or more sugar alcohols and a bulking agent. The proteinaceous material found in this embodiment comprises an isolated soy protein having a degree of hydrolysis of from about 75 STNBS to about 125 STNBS. More suitably, the proteinaceous material found in the high protein food bars of this embodiment is comprised of isolated soy protein having a degree of hydrolysis of from about 80 STNBS to about 120 STNBS. As such, ISP 1-type and/or ISP 2-type isolated soy proteins are suitable for use in this embodiment.

In another embodiment, when the carbohydrate material of the high protein food bar comprises one or more sugar alcohols and a bulking agent, the proteinaceous material includes an isolated soy protein having a degree of hydrolysis of from about 40 STNBS to about 55 STNBS. More suitably, the proteinaceous material found in the high protein food bars of this embodiment is comprised of isolated soy protein having a degree of hydrolysis of about 45 STNBS. As such, ISP 4-type isolated soy proteins are suitable for use in this embodiment.

In another embodiment, when the carbohydrate material of the high protein food bar comprises one or more sugar alcohols and a bulking agent, the proteinaceous material for use in the high protein food bar comprises a first isolated soy protein having a degree of hydrolysis of from about 75 STNBS to about 125 STNBS and a second isolated soy protein having a degree of hydrolysis of from about 25 STNBS to about 35 STNBS. More suitably, the proteinaceous material of this high protein food bar comprises a first isolated soy protein having a degree of hydrolysis of from about 80 STNBS to about 120 STNBS and a second isolated soy protein having a degree of hydrolysis of from about 30 STNBS to about 35 STNBS. As such, ISP 1-type and/or ISP 2-type isolated soy proteins in combination with ISP 3-type isolated soy proteins are suitable for use in this embodiment.

In another embodiment, when the carbohydrate material of the high protein food bar comprises one or more sugar alcohols and a bulking agent, the proteinaceous material can include a co-processed soy protein/milk protein blend having a degree of hydrolysis of from about 45 STNBS to about 65 STNBS. More suitably, the proteinaceous material comprises a co-processed soy protein/milk protein blend having a degree of hydrolysis of from about 49 STNBS to about 61 STNBS.

In another embodiment, the carbohydrate material of the high protein food bar comprises sugar syrups. The isolated soy protein used in the proteinaceous material of this high protein food bar has a degree of hydrolysis of from about 25 STNBS to about 35 STNBS. More suitably, the isolated soy protein has a degree of hydrolysis of from about 30 STNBS to about 35 STNBS. As such, ISP 3-type isolated soy proteins are suitable for use in this embodiment.

In another embodiment, when the carbohydrate material of the high protein food bar comprises sugar syrups, the isolated soy protein for use in the proteinaceous material has a degree of hydrolysis of from about 40 STNBS to about 55 STNBS. More suitably, the isolated soy protein has a degree of hydrolysis of about 45 STNBS. As such, ISP 4-type isolated soy proteins are suitable for use in this embodiment.

In another embodiment, when the carbohydrate material of the high protein food bar comprises sugar syrups, the proteinaceous material for use in the high protein food bar comprises a first isolated soy protein having a degree of hydrolysis of from about 75 STNBS to about 125 STNBS and a second isolated soy protein having a degree of hydrolysis of from about 25 STNBS to about 35 STNBS. More suitably, the proteinaceous material of this high protein food bar comprises a first isolated soy protein having a degree of hydrolysis of from about 80 STNBS to about 120 STNBS and a second isolated soy protein having a degree of hydrolysis of from about 30 STNBS to about 35 STNBS. As such, ISP 1-type and/or ISP 2-type isolated soy proteins in combination with ISP 3-type isolated soy proteins are suitable for use in this embodiment.

In another embodiment, when the carbohydrate material of the high protein food bar comprises sugar syrups, the proteinaceous material can include a co-processed soy protein/milk protein blend having a degree of hydrolysis of from about 45 STNBS to about 65 STNBS. More suitably, the co-processed soy protein/milk protein blend for use in the proteinaceous material has a degree of hydrolysis of from about 49 STNBS to about 61 STNBS.

Additionally, the isolated soy proteins used in the high protein food bars have an improved soluble solids index. Suitably, in one embodiment, when the high protein food bar comprises one or more sugar alcohols and a bulking agent as the carbohydrate material, the isolated soy protein for use in the proteinaceous material of the high protein food bars has a soluble solids index of greater than about 70%. More suitably, the isolated soy protein used in the high protein food bars of this embodiment has a soluble solids index of greater than about 80%, and even more suitably, a soluble solids index of greater than about 90%. As such, ISP 1-type and/or ISP 2-type isolated soy proteins are suitable for use in this embodiment.

In another embodiment, when the high protein food bar comprises one or more sugar alcohols and a bulking agent as the carbohydrate material, the isolated soy protein for use in the proteinaceous material has a soluble solids index of from about 30% to about 45%. More suitably, the isolated soy protein used in the high protein food bars of this embodiment has a soluble solids index of from about 30% to about 40%, and even more suitably of about 35%. As such, ISP 4-type isolated soy proteins are suitable for use in this embodiment.

In another embodiment, when the high protein food bar comprises one or more sugar alcohols and a bulking agent as the carbohydrate material, the proteinaceous material of the high protein food bars comprises a first isolated soy protein having a soluble solids index of greater than about 70% and a second isolated soy protein having a soluble solids index of from about 30% to about 60%. More suitably, the first isolated soy protein used in the high protein food bars of this embodiment has a soluble solids index of greater than about 80%, and even more suitably, a soluble solids index of greater than about 90%, and the second isolated soy protein has a soluble solids index of from about 40% to about 50%. As such, ISP 1-type and/or ISP 2-type isolated soy proteins in combination with ISP 3-type isolated soy proteins are suitable for use in this embodiment.

In another embodiment, when the carbohydrate material comprises one or more sugar alcohols and a bulking agent, the proteinaceous material can include a co-processed soy protein/milk protein blend having a soluble solids index of from about 30% to about 60%. More suitably, the co-processed soy protein/milk protein blend has a soluble solids index of from about 35% to about 45%.

In one embodiment where the high protein food bar comprises sugar syrup as the carbohydrate material, the isolated soy protein for use in the proteinaceous material of the high protein food bars has a soluble solids index of from about 30% to about 60%. More suitably, the isolated soy protein for use in the high protein food bars of this embodiment has a soluble solids index of from about 40% to about 50%. As such, ISP 3-type isolated soy proteins are suitable for use in this embodiment.

In another embodiment, when the high protein food bar comprises sugar syrup as the carbohydrate material, the isolated soy protein for use in the proteinaceous material has a soluble solids index of from about 30% to about 45%. More suitably, the isolated soy protein used in the high protein food bars of this embodiment has a soluble solids index of from about 30% to about 40%, and even more suitably of about 35%. As such, ISP 4-type isolated soy proteins are suitable for use in this embodiment.

In another embodiment, where the high protein food bar comprises sugar syrup as the carbohydrate material, the proteinaceous material of the high protein food bars comprises a first isolated soy protein having a soluble solids index of greater than about 70% and a second isolated soy protein having a soluble solids index of from about 30% to about 60%. More suitably, the first isolated soy protein for use in this high protein food bar has a soluble solids index of greater than about 80%, and even more suitably, of greater than about 90%, and the second isolated soy protein has a soluble solids index of from about 40% to about 50%. As such, ISP 1-type and/or ISP 2-type isolated soy proteins in combination with ISP 3-type isolated soy proteins are suitable for use in this embodiment.

In yet another embodiment, when the carbohydrate material comprises a sugar syrup, the proteinaceous material can include a co-processed soy protein/milk protein blend having a soluble solids index of from about 30% to about 60%. More suitably, the co-processed soy protein/milk protein blend has a soluble solids index of from about 35% to about 45%.

As used herein, the term “soluble solids index” (“SSI”) refers to the solubility of a soy protein material in an aqueous solution as measured according to the following formula:
SSI(%) (Soluble Solids/Total Solids)×100
wherein the Soluble Solids and Total Solids is determined as follows: a 12.5-gram sample of the isolated soy protein is obtained; 487.5 grams of deionized water is added to a quart blender jar; add 2 to 3 drops of defoamer (available as Antifoam B Emulsion, from Dow Corning (Midland, Mich.)), which has been diluted with water to a 1:1 ratio of defoamer:water, to the blender jar; blend the deionized water and defoamer in a blender at a speed of about 14,000 revolutions per minute (rpm); over a period of 30 seconds, the isolated soy protein sample is added to the blender and then blended for an additional 60 seconds; the resulting mixture is then transferred to a 500-milliliter beaker containing a magnetic stirring bar, and the beaker is then covered with plastic wrap or aluminum foil; place the covered beaker on a stirring plate and stir the mixture at a speed of 1500 rpm for 30 minutes; 200 grams of the mixture is then transferred into one centrifuge tube and another 200 grams of the mixture is then transferred into a second centrifuge tube; both centrifuge tubes are centrifuged using an IEC Model K centrifuge at 1500 rpm for 10 minutes; 50 milliliters of supernatant from each centrifuge tube are placed in separate plastic cups. The Soluble Solids is then determined by drying a 5-gram sample of each supernatant at 130° C. for 2 hours, measuring the weight of each dried sample, and averaging the weights. The Total Solids is determined by drying two 5-gram samples of mixture that were not centrifuged, measuring the weight of each dried sample, and averaging the weights. Soluble solids index (SSI) is finally calculated from the Soluble Solids and Total Solids using the formula above.
Formation of Milk Proteins

In addition to the isolated soy protein, the proteinaceous material utilized in the high protein food bars may comprise one or more milk proteins (i.e., cow's milk proteins). Some suitable milk proteins for use in the proteinaceous material used in the high protein food bars of the present disclosure can be selected from the group consisting of calcium caseinate, whey protein isolate (hydrolyzed and/or unhydrolyzed), whey protein concentrate, whey protein hydrolysates, sodium caseinate, acid casein, skim or whole milk powder, milk protein concentrate, total milk protein, and combinations thereof. Particularly preferred milk proteins include calcium caseinate, whey protein isolate (hydrolyzed and/or unhydrolyzed), and whey protein concentrate.

As noted above, the proteinaceous material can comprises one or more milk proteins. For example, in one embodiment, the proteinaceous material comprises a whey protein isolate as a first milk protein and calcium caseinate as a second milk protein.

Typically, caseins, such as used to make calcium caseinate or sodium caseinate, are by-products of the dairy industry and are prepared from skim milk by coagulation in the form of a curd. Generally, the casein is coagulated by acid coagulation, natural souring, or rennet coagulation. To effect acid coagulation of casein, a suitable acid, preferably hydrochloric acid, is added to milk to lower the pH of the milk to about the isoelectric point of the casein, preferably to a pH of from about 4.0 to about 5.0, and more preferably to a pH of from about 4.6 to about 4.8. To effect coagulation by natural souring, milk is held in vats to ferment, causing lactic acid to form. The milk is fermented for a sufficient period of time to allow the formed lactic acid to coagulate a substantial portion of the casein in the milk. To effect coagulation of casein with rennet, sufficient rennet is added to the milk to precipitate a substantial portion of the casein in the milk. Typically, to produce calcium caseinate, after the acid coagulation, natural souring, or rennet coagulation of the casein is completed, calcium hydroxide is used to neutralize the casein.

Whey protein isolates (“WPI”) and whey protein concentrates (“WPC”) are obtained from the watery part of milk separated from curd in the process of making cheese. Specifically, WPIs and WPCs are obtained by a filtration of cheese whey, such as a partially delactosed cheese whey. Alternatively, the WPIs and WPCs may be obtained by processes such as electrodialysis, reverse osmosis, and/or ultrafiltration of cheese whey or partially delactosed cheese whey. Suitable processes for producing the WPIs and WPCs are disclosed in U.S. Pat. No. 3,547,900, issued to C. S. Dienst, et al. (Dec. 15, 1970) and U.S. Pat. No. 6,630,320, issued to Davis, et al. (Oct. 7, 2003), both of which are incorporated by reference.

WPIs and WPCs typically comprise β-lactoglobulin, β-lactalbumin, bovine serum albumin, immunoglobulins, minerals, lactose, and moisture. The protein content of WPI typically is greater than about 95% (by weight). WPCs typically comprise from about 30% (by weight) to about 80% (by weight) protein.

Some examples of suitable commercially available milk proteins for use in the high protein food bars described herein include Farbest 290, which is a calcium caseinate (available from Farbest Brands, Montvale, N.J.), Protient, which is a whey protein isolate (available from Protient, Inc., St. Paul, Minn.), Farbest 80, which is a whey protein concentrate (available from Farbest Brands, Montvale, N.J.), and Barflex, which is a whey protein isolate (available from Glanbia Foods, Inc., Twin Falls, Id.).

Carbohydrate Material

In addition to the proteinaceous material, the high protein food bars of the present disclosure comprise carbohydrate material. As noted above, in one embodiment, the high protein food bar comprises from about 35% (by total weight food bar) to about 50% (by total weight food bar) carbohydrate material in addition to the proteinaceous material. Typically, the carbohydrate material of this embodiment comprises one or more sugar alcohols and a bulking agent.

Sugar alcohols may commonly be referred to as polyols or polyhydric alcohols. Different sugar alcohols have different effects on food bar texture. For example, in general, lower molecular weight sugar alcohols tend to produce softer food bars that retain a soft texture during prolonged storage. Suitable sugar alcohols may be selected from the group consisting of sorbitol, maltitol, glycerin, lactitol, mannitol, isomalt, xylitol, hydrogenated starch syrups, erythritol, and the like, and combinations thereof. When using one or more sugar alcohols as the carbohydrate material, the carbohydrate material suitably comprises from about 50% (by weight total carbohydrate material) to about 95% (by weight total carbohydrate material) sugar alcohol. More suitably, the carbohydrate material of this embodiment comprises from about 80% (by weight total carbohydrate material) to about 90% (by weight total carbohydrate material) sugar alcohol.

In one embodiment, when the carbohydrate material comprises one or more sugar alcohols, the carbohydrate material additionally comprises one or more bulking agents. Bulking agents generally contribute to the overall volume of food products, without contributing significantly to the product's available energy; that is, without significantly increasing the caloric content of the food product. For example, the sugars present in food products typically contribute to the energy available in food products; as such, low-energy food products often need bulking agents added to them to replace the bulk normally provided by sugar. Suitable bulking agents for use in the present disclosure include, for example, polydextrose, resistant starch, pectin, gelatin, xanthan, gellan, algin, guar, konjak, locust bean, oat fiber, soy fiber, fiuctooligosaccharides, inulin, iso-maltooligosaccharides, wheat dextrin, corn dextrin, pea fiber, and combinations thereof. A particularly preferred bulking agent is polydextrose. Suitably, the carbohydrate material comprises from about 5% (by weight total carbohydrate material) to about 30% (by weight total carbohydrate material) bulking agent. More suitably, the carbohydrate material comprises from about 5% (by weight total carbohydrate material) to about 20% (by weight total carbohydrate material) bulking agent.

In an alternative embodiment, in addition to the proteinaceous material, the high protein food bars comprise from about 40% (by total weight food bar) to about 55% (by total weight food bar) carbohydrate material. The carbohydrate material in this embodiment typically comprises a sugar syrup. Sugar syrups are typically used in food bars for the sweetness taste they impart. Suitably, the sugar syrups provide a sweet taste in proportion to the types and quantities of sugars present and contribute to the texture of the bar. This reaction results in a reduced need for additional high intensity sweeteners to impart a desirable sweet taste to food bars. In general, sugar syrups comprised of lower levels of complex carbohydrates tend to make softer food bars. For example, a 63 DE (dextrose equivalency) corn syrup will produce a softer food bar compared to 42 DE corn syrup. The sugar syrups may suitably be selected from the group consisting of high fructose corn syrup, corn syrup, rice syrup, rice syrup solids, sucrose, honey, and glucose-fructose syrup, fruit juice concentrates, fruit juices, grain dextrins, and combinations thereof, and may be in solid/powdered or liquid form. In one embodiment, the sugar syrup is high dextrose equivalency (DE) acid-enzyme converted corn syrup, available as 63 DE corn syrup from Tate & Lyle (Decatur, Ill.). 63 DE corn syrup is produced by enzymatically converting the long chain dextrins into mono- and disaccharides, giving this corn syrup a high concentrate of fermentable sugars. In another embodiment, the sugar syrup is high fructose corn syrup. High fructose corn syrup is a high conversion corn syrup that is enzymatically derived and isomerized to produce a saccharide composition comprised primarily of dextrose and fructose.

In one embodiment, when the carbohydrate material comprises sugar syrups, the carbohydrate material additionally comprises one or more bulking agents. Suitable bulking agents for use with the sugar syrups can include, for example, polydextrose, resistant starch, pectin, gelatin, xanthan, gellan, algin, guar, konjak, locust bean, oat fiber, soy fiber, fiuctooligosaccharides, inulin, iso-maltooligosaccharides, wheat dextrin, corn dextrin, pea fiber, and combinations thereof.

In still another embodiment, the carbohydrate material can include sugar syrups, one or more sugar alcohols, and one or more bulking agents. Suitably sugar syrups, sugar alcohols, and bulking agents can include those described herein above.

In addition to the primary ingredients (i.e., proteinaceous material, sugar alcohols, sugar syrup, etc.) of the high protein food bars described above, the high protein food bars may comprise additional optional components to further improve various properties of the high protein food bar. Some potential additional components include flavoring agents, vitamins, minerals, shortening, cake shortening, sucralose, saccharin, aspartame, acesulfame potassium, thaumatin, glycyithizin, salt, lecithin, fruit pieces, nuts, tree nuts, and nut butters, probiotics, prebiotics, leavening agents, peanut flour, rolled oats, nugget/crisp particulates, coloring agents, antioxidants, fruit juice concentrates, acidulants such as citric acid and malic acid, sodium benzoate, potassium sorbate, neotame, acesulfame, chocolate liquor, and combinations thereof. Suitable flavoring agents can include, for example, cocoa powder, peanut flavor, vanilla, chocolate, and caramel.

Processes for Producing High Protein Food Bars

In addition to the high protein food bars, the present disclosure is also directed to processes for producing these high protein food bars. In one embodiment, the process comprises first combining a proteinaceous material, a carbohydrate material and any other components, to form a dough. In one embodiment, the proteinaceous material comprises from about 33% (by total weight proteinaceous material) to about 75% (by total weight proteinaceous material) isolated soy protein and from about 25% (by total weight proteinaceous material) to about 67% (by total weight proteinaceous material) milk protein, wherein the isolated soy protein has a soluble solids index of greater than about 70% and has a degree of hydrolysis of from about 75 STNBS to about 125 STNBS. The carbohydrate material comprises one or more sugar alcohols and a bulking agent

In another embodiment, wherein the process comprises combining a proteinaceous material and a carbohydrate material to form a dough, the proteinaceous material includes from about 10% (by total weight proteinaceous material) to about 90% (by total weight proteinaceous material) isolated soy protein and from about 10% (by total weight proteinaceous material) to about 90% (by total weight proteinaceous material) milk protein, wherein the isolated soy protein has a soluble solids index of from about 30% to about 45% and has a degree of hydrolysis of from about 40 STNBS to about 55 STNBS. The carbohydrate material comprises one or more sugar alcohols and a bulking agent.

In both of the above embodiments, once the dough is formed, it is sheeted and divided into individual high protein food bars of a desired size. In a preferred embodiment, the proteinaceous material and the carbohydrate material are separately prepared and then combined to form the dough.

To produce the proteinaceous material, isolated soy proteins and milk proteins are blended together. In one suitable embodiment, the isolated soy proteins and milk proteins are blended using a mixer at a speed of about 40 to about 50 revolutions per minute (rpm) for one minute to produce the dough. One suitable mixer is a Winkwoith mixer (available from Winkworth Machinery, Ltd., Reading, England).

As noted above, in one embodiment, the proteinaceous material comprises one isolated soy protein in combination with the milk protein. In another embodiment, the proteinaceous material comprises a first isolated soy protein and a second isolated soy protein in combination with the milk protein. In yet another embodiment, the proteinaceous material comprises a first isolated soy protein and a second isolated soy protein in combination with a first milk protein and a second milk protein. In yet another embodiment, the isolated soy protein and milk proteins are mixed to form a protein mixture which may be co-processed as described above to form a co-processed soy protein/milk protein blend for use as the proteinaceous material. When the proteinaceous material is a co-processed soy protein/milk protein blend, the proteinaceous material is produced by blending together from about 10% (by total weight blend) to about 90% (by total weight blend) isolated soy protein with from about 10% (by total weight blend) to about 90% (by total weight blend) milk protein. More suitably, the proteinaceous material is produced by blending together from about 33% (by total weight blend) to about 75% (by total weight blend) isolated soy protein with from about 25% (by total weight blend) to about 67% (by total weight blend) milk protein. Even more suitably, the proteinaceous material is produced by blending together about 50% (by total weight blend) isolated soy protein and about 50% (by total weight blend) milk protein

As noted above, in one embodiment, when the high protein food bar comprises one or more sugar alcohols and a bulking agent as the carbohydrate material, the isolated soy protein for use in the proteinaceous material has a degree of hydrolysis, as determined using the STNBS method described herein above, of from about 75 STNBS to about 125 STNBS. More suitably, the isolated soy protein has a degree of hydrolysis of from about 80 STNBS to about 120 STNBS. Additionally, in the above embodiment, the isolated soy protein for use in the proteinaceous material has a soluble solids index of greater than about 70%. More suitably, the isolated soy protein has a soluble solids index of greater than about 80%, and even more suitably, a soluble solids index of greater than about 90%.

In another embodiment, when the high protein food bar comprises one or more sugar alcohols and a bulking agent as the carbohydrate material, the isolated soy protein for use in the proteinaceous material has a degree of hydrolysis of from about 40 STNBS to about 55 STNBS. More suitably, the isolated soy protein has a degree of hydrolysis of about 45 STNBS. The isolated soy protein for use in the proteinaceous material of this embodiment additionally has a soluble solids index of from about 30% to about 45%, more suitably from about 30% to about 40%, and even more suitably, about 35%.

In another embodiment, when the high protein food bar comprises one or more sugar alcohols and a bulking agent as the carbohydrate material, the proteinaceous material includes a first isolated soy protein having a degree of hydrolysis of from about 75 STNBS to about 125 STNBS and a second isolated soy protein having a degree of hydrolysis of from about 25 STNBS to about 35 STNBS. More suitably, the first isolated soy protein has a degree of hydrolysis of from about 80 STNBS to about 120 STNBS and the second isolated soy protein has a degree of hydrolysis of from about 30 STNBS to about 35 STNBS.

Additionally, the first isolated soy protein of this embodiment has a soluble solids index of greater than about 70%, more suitably, greater than about 80%, and even more suitably, greater than about 90%. The second isolated soy protein of this embodiment suitably has a soluble solids index of from about 30% to about 60%, and more suitably, from about 40% to about 50%.

In yet another embodiment, when the carbohydrate material includes one or more sugar alcohols and a bulking agent, the proteinaceous material includes a co-processed soy protein/milk protein blend having a degree of hydrolysis of from about 45 STNBS to about 65 STNBS. More suitably, the co-processed soy protein/milk protein blend has a degree of hydrolysis of from about 49 STNBS to about 61 STNBS. Additionally, the co-processed soy protein/milk protein blend for use in the proteinaceous material of this embodiment suitably has a soluble solids index of from about 30% to about 60%, and more suitably, from about 35% to about 45%.

In one embodiment, to produce the carbohydrate material, one or more sugar alcohols and a bulking agent are blended together. Suitably, the sugar alcohols and bulking agent are blended using a mixer, such as a Winkworth mixer, at a speed of about 40 to about 50 revolutions per minute (rpm) for one minute. In one embodiment, from about 80% (by total weight carbohydrate material) to about 90% (by total weight carbohydrate material) sugar alcohol is blended with from about 10% (by total weight carbohydrate material) to about 20% (by total weight carbohydrate material) bulking agent.

Once the carbohydrate material is produced, the carbohydrate material may be heated to a temperature of about 38° C. (100° F.) in a steam jacketed kettle or microwave oven. Once the carbohydrate material is heated, the proteinaceous material and carbohydrate material can be combined by any manner known in the art. In one suitable embodiment, the two materials are blended together to form the dough using a mixer, such as the Winkworth mixer, at a speed of from about 40 to about 50 revolutions per minute (rpm) for 1 to 5 minutes.

Suitably, the high protein food bar of the above embodiments will comprise from about 35% (by total weight food bar) to about 55% (by total weight food bar) proteinaceous material and from about 35% (by total weight food bar) to about 50% (by total weight food bar) carbohydrate material.

In addition to the proteinaceous material and carbohydrate material, additional components can be added to the dough. The additional components can be added to the proteinaceous material prior to combining the proteinaceous material and carbohydrate material; to the carbohydrate material prior to combining the proteinaceous material and carbohydrate material; or to the combined proteinaceous material and carbohydrate material. Examples of suitable additional components can include flavoring agents, vitamins, minerals, shortening, cake shortening, sucralose, saccharin, aspartame, acesulfame potassium, thaumatin, glycyrrhizin, salt, lecithin, fruit pieces, nuts, tree nuts, and nut butters, probiotics, prebiotics, leavening agents, peanut flour, rolled oats, nugget/crisp particulates, coloring agents, antioxidants, fruit juice concentrates, acidulants such as citric acid and malic acid, sodium benzoate, potassium sorbate, neotame, acesulfame, chocolate liquor, and combinations thereof.

Once the dough is formed, the dough may be sheeted out onto a marble or other suitable slab using a rolling pin. The dough can be sheeted in any manner known in the art to produce the desired sheeting characteristics.

Finally, the sheeted dough can be cut or divided into individual high protein food bars of any desired size. Suitably, the dough is cut or divided using a pizza cutter into individual high protein food bars being from about 102 millimeters in length, about 10 millimeters in height, and about 35 millimeters wide.

In an alternative embodiment, the process for producing a high protein food bar comprises: combining a first mixture and a second mixture to form a dough. In one embodiment, the first mixture includes a combination of proteinaceous material comprising about 100% (by total weight proteinaceous material) isolated soy protein and solid/powdered carbohydrate material. The isolated soy protein has a soluble solids index of from about 30% to about 45% and a degree of hydrolysis of from about 40 STNBS to about 55 STNBS. The second mixture includes liquid carbohydrate material.

In another embodiment, the first mixture includes a combination of proteinaceous material comprising from about 33% (by total weight proteinaceous material) to about 75% (by total weight proteinaceous material) isolated soy protein and from about 25% (by total weight proteinaceous material) to about 67% (by total weight proteinaceous material) milk protein, and solid/powdered carbohydrate material. The isolated soy protein has a soluble solids index of from about 30% to about 60% and has a degree of hydrolysis of from about 25 STNBS to about 35 STNBS. More suitably, the isolated soy protein has a soluble solids index of from about 40% to about 50% and has a degree of hydrolysis of from about 30 STNBS to about 35 STNBS. The second mixture includes liquid carbohydrate material.

In yet another embodiment, the first mixture includes a combination of proteinaceous material comprising from about 10% (by total weight proteinaceous material) to about 90% (by total weight proteinaceous material) isolated soy protein and from about 10% (by total weight proteinaceous material) to about 90% (by total weight proteinaceous material) milk protein, and solid/powdered carbohydrate material. Suitably, the isolated soy protein of this embodiment has a soluble solids index of from about 30% to about 45%, more suitably from about 30% to about 40%, and even more suitably about 35%. Additionally, the isolated soy protein has a degree of hydrolysis of from about 40 STNBS to about 55 STNBS, and more suitably, about 45 STNBS.

In another embodiment, the first mixture includes a combination of proteinaceous material comprising from about 33% (by total weight proteinaceous material) to about 75% (by total weight proteinaceous material) isolated soy protein and from about 25% (by total weight proteinaceous material) to about 67% (by total weight proteinaceous material) milk protein, and solid/powdered carbohydrate material. Suitably, the isolated soy protein of this embodiment can consist of a first isolated soy protein having a soluble solids index of greater than about 70% and having a degree of hydrolysis of from about 75 STNBS to about 125 STNBS and a second isolated soy protein having a soluble solids index of from about 30% to about 60% and a degree of hydrolysis of from about 25 STNBS to about 35 STNBS. More suitably, the first isolated soy protein has a soluble solids index of greater than about 80%, and even more suitably, greater than about 90%, and has a degree of hydrolysis of from about 80 STNBS to about 120 STNBS and the second isolated soy protein has a soluble solids index of from about 40% to about 50% and has a degree of hydrolysis of from about 30 STNBS to about 35 STNBS. The second mixture includes liquid carbohydrate material.

Once the mixtures are combined, the dough is sheeted out and divided into individual high protein food bars of a desired size. In a preferred embodiment, the proteinaceous material and carbohydrate material are separately prepared and then combined to form the dough.

To produce the first mixture, proteinaceous material and all other dry and powdered ingredients such as solid/powdered carbohydrate material and optional ingredients such as cocoa powder, vitamins and minerals, artificial sweeteners, and the like are combined. As used herein, “solid/powdered carbohydrate material” means a carbohydrate material that has been dehydrated into a powdered ingredient, typically containing less than about 5% moisture. In one suitable embodiment, the proteinaceous material is combined with the other dry and powdered ingredients using a mixer, such as the Winkworth mixer, mixing at a speed of from about 40 to about 50 rpm. Suitably, the other dry and powdered ingredients are blended into the proteinaceous material in the amounts of from about 80% (by total weight of mixture) to about 97% (by total weight of mixture) proteinaceous material and from about 3% (by total weight of mixture) to about 20% (by total weight of mixture) other dry and powdered ingredients.

As noted above, in one embodiment, the proteinaceous material comprises a blend of from about 10% (by total weight proteinaceous material) to about 90% (by total weight proteinaceous material) isolated soy protein with from about 10% (by total weight proteinaceous material) to about 90% (by total weight proteinaceous material) milk protein. More suitably, the proteinaceous material is produced by blending together from about 33% (by total weight proteinaceous material) to about 75% (by total weight proteinaceous material) isolated soy protein with from about 25% (by total weight proteinaceous material) to about 67% (by total weight proteinaceous material) milk protein. Even more suitably, the proteinaceous material is produced by blending together about 50% (by total weight proteinaceous material) isolated soy protein and about 50% (by total weight proteinaceous material) milk protein. The isolated soy proteins and milk proteins can be combined by any manner known in the art. In one embodiment, the isolated soy proteins and milk proteins are blended together using a mixer at a speed of about 40 to about 50 rpm for one minute. A suitable mixer is a Winkworth mixer (available from Winkworth Machinery, Ltd., Reading, England).

In a further embodiment, once the isolated soy protein and milk proteins are mixed, the protein mixture is co-processed using the method described above to form a co-processed soy protein/milk protein blend for use in the proteinaceous material. When the proteinaceous material includes a co-processed soy protein/milk protein blend, the co-processed soy protein/milk protein blend is produced by blending together from about 10% (by total weight blend) to about 90% (by total weight blend) isolated soy protein with from about 10% (by total weight blend) to about 90% (by total weight blend) milk protein. More suitably, the co-processed soy protein/milk protein blend is produced by blending together from about 33% (by total weight blend) to about 75% (by total weight blend) isolated soy protein with from about 25% (by total weight blend) to about 67% (by total weight blend) milk protein. Even more suitably, the co-processed soy protein/milk protein blend is produced by blending together about 50% (by total weight blend) isolated soy protein and about 50% (by total weight blend) milk protein.

In a separate container, a second mixture containing liquid carbohydrate material and optional liquid flavors is produced. As used herein, “liquid carbohydrate material” means carbohydrate material that is high enough in solids content to be microbially stable at ambient temperatures. Typically, the liquid carbohydrate material has a solids content of from about 72% to about 82%. In one suitable embodiment, the liquid carbohydrate material and liquid flavors are blended together using a spatula to thoroughly mix the carbohydrate material and flavors together to form a uniform mixture.

Once the second mixture is produced, the second mixture is heated to a temperature of about 38° C. (100° F.) in a steam jacketed kettle or microwave oven to decrease the viscosity, resulting in an increased flowability of the second mixture.

Once the second mixture is heated, the first mixture and second mixture can be combined by any manner known in the art. In one suitable embodiment, the first and second mixtures are blended together to form the dough using a mixer, such as the Winkworth mixer, at a speed of from about 40 to about 50 revolutions per minute (rpm) for a period of from about one minutes to about three minutes and forty-five seconds.

Suitably the high protein food bar of this embodiment will comprise from about 25% (by total weight food bar) to about 50% (by total weight food bar) proteinaceous material and from about 40% (by total weight food bar) to about 55% (by total weight food bar) carbohydrate material.

In addition to the first and second mixtures, additional components can be added to the dough. The additional components can be added to the first mixture prior to combining the first and second mixtures; to the second mixture prior to combining the first and second mixtures; or to the combined first and second mixture. Suitable additional components that can be added to the dough include, for example, flavoring agents, vitamins, minerals, shortening, cake shortening, sucralose, saccharin, aspartame, acesulfame potassium, thaumatin, glycyrrhizin, salt, lecithin, fruit pieces, nuts, tree nuts, and nut butters, probiotics, prebiotics, leavening agents, peanut flour, rolled oats, nugget/crisp particulates, coloring agents, antioxidants, fruit juice concentrates, acidulants such as citric acid and malic acid, sodium benzoate, potassium sorbate, neotame, acesulfame, chocolate liquor, and combinations thereof.

Once the dough is formed, the dough may be sheeted out onto a marble or other suitable slab using a rolling pin. The dough can be sheeted in any manner known in the art to produce the desired sheeting characteristics.

Finally, the sheeted dough can be cut or divided into individual high protein food bars. Suitably, the dough is cut or divided using a pizza cutter into individual high protein food bars being, for example, from about 102 millimeters in length, about 10 millimeters in height, and about 35 millimeters wide.

In all of the above described processes for producing a high protein food bar, the individual high protein food bars can further be baked after being divided. In one embodiment, the individual high protein food bars can be baked in an oven at a temperature of about 177° C. (350° F.) for a period of from about 6 minutes to about 7 minutes.

The high protein food bars produced in the present disclosure can be used alone or in combination with other food bars. For example, in one embodiment, the high protein food bar produced in the present disclosure can be used as one or more layers of a multi-layered food bar.

High Protein Food Bar Characteristics

The high protein food bars produced by the processes of the present disclosure have improved texture. Specifically, the high protein food bars produced herein are softer than conventional high protein food bars, providing a more desired end product.

The softness of the high protein food bar may be measured in terms of grams of force necessary to compress the bar a preset distance using a probe (i.e., mechanical hardness). The mechanical hardness may be measured using a Texture Expert Exceed Texture Analyzer (“TA.TXT2”) (50-kilogram load cell) (available from Stable Micro Systems Ltd., England) and corresponding software, where a TA-55 probe is the probe used for determining the mechanical hardness of the food bar. The force of the TA.TXT2 is calibrated for zero force (no weight on the calibration platform) and for 5 kilograms (5 kilograms weight on the calibration platform). The probe is calibrated by setting the distance of the probe as close as possible to the TA.TXT2 platform. The mechanical hardness of the high protein food bar is measured by placing the high protein food bar on the platform centered under the probe. The TA.TXT2 is set to move the probe 1 millimeters/second at a force of 10 grams, and the probe is driven into the high protein food bar up to half the height of the high protein food bar. The TA.TXT2 is also set to acquire 200 data points per second during the insertion of the probe into the high protein food bar. The high protein food bar is punctured two more times with the probe and the mechanical hardness is measured for each puncture. The measured “mechanical hardness” is then calculated as the average of the three measurements. Such measuring techniques are known to those skilled in the art.

Suitably, when the high protein food bar comprises one or more sugar alcohols and a bulking agent as the carbohydrate material, the high protein food bar of the present disclosure has a mechanical hardness of less than 2500 grams force. More suitably, when the high protein food bar comprises one or more sugar alcohols and a bulking agent as the carbohydrate material, the high protein food bar has a mechanical hardness of less than about 2000 grams force, and even more suitably, of less than about 1700 grams force.

When the high protein food bar comprises proteinaceous material and carbohydrate material such as sugar syrup, the high protein food bar suitably has a mechanical hardness of less than about 2000 grams force. More suitably, when the high protein food bar comprises proteinaceous material and carbohydrate material such as sugar syrup, the high protein food bar has a mechanical hardness of less than about 1500 grams force, and even more suitably, less than about 1000 grams force.

In addition to having improved mechanical hardness, the high protein food bars have improved chewiness as measured using a subjective sensory panel. Specifically, chewiness is measured using a 15-point hedonic scale. Specifically, the high protein food bars to be evaluated are cut into bite-sized (½ inch by ½ inch) samples. After being screened to verify their ability to evaluate chewiness, ten trained descriptive panelists taste the bite-sized samples and evaluate the chewiness of the samples. According to the 15-point hedonic scale, a score of 15 is extremely chewy and a score of 1 is not chewy at all. Prior to tasting the samples, anchor points are set using commercial samples which have established chewiness guidelines. The commercial samples for use as anchor points and their corresponding hedonic score for chewiness are as follows: Atkins® muffin bar (available from Atkins Nutritionals, Inc., Ronkonkoma, N.Y.)=3, Met-Rx® extruded bar (available from Met-Rx USA, Inc., Boca Raton, Fla.)=5, Original Powerbar® (available from Powerbar, Inc., Berkeley, Calif.)=9, and Tootsie Rolls® (available from Tootsie Roll Industries, Inc., Chicago, Ill.)=15.

When the high protein food bar comprises proteinaceous material and carbohydrate material such as sugar syrups, the high protein food bar suitably has a chewiness score of from about 4.0 to about 10.0. More suitably, the high protein food bar has a chewiness score of from about 6.0 to about 8.0.

Additionally, the high protein food bars of the present disclosure show an extended shelf-life; that is, the high protein food bars described herein maintain their textural softness and palatability for an extended period of time as compared to conventional high protein food bars. A long shelf-life is especially desirable in high protein food bars since such food bars are often displayed for sale on a retail shelf for extended periods of time. Also, high protein food bars may be stored prior to shipment for extended periods of time. One suitable method of determining shelf-life is by measuring the mechanical hardness difference before and after storage and dividing that number by the number of days of storage (i.e., the hardening rate).

When the high protein food bars comprise proteinaceous material and one or more sugar alcohols and a bulking agent as the carbohydrate material, the high protein food bars suitably have a hardening rate of less than 170 grams force per day. More suitably, when the high protein food bars comprise proteinaceous material and one or more sugar alcohols and a bulking agent as the carbohydrate material, the high protein food bars have a hardening rate of less than 100 grams force per day, even more suitably, less than 50 grams force per day.

When the high protein food bars comprise proteinaceous material and carbohydrate material such as sugar syrup, the high protein food bars suitably have a hardening rate of less than 275 grams force per day. More suitably, when the high protein food bars comprise proteinaceous material and carbohydrate material such as sugar syrup, the high protein food bars have a hardening rate of less than 100 grams force per day, even more suitably, less than 50 grams force per day.

In one particularly preferred embodiment of the present disclosure, the high protein food bar comprises from about 30% (by total weight food bar) to about 50% (by total weight food bar) proteinaceous material and from about 40% (by total weight food bar) to about 55% (by total weight food bar) carbohydrate material, wherein the proteinaceous material comprises a combination of a first isolated soy protein, a second isolated soy protein, a whey protein isolate, and a calcium caseinate. The first isolated soy protein has a soluble solids index of greater than about 70% and has a degree of hydrolysis of from about 75 STNBS to about 125 STNBS. The second isolated soy protein has a soluble solids index of from about 30% to about 60% and has a degree of hydrolysis of from about 25 STNBS to about 35 STNBS. The carbohydrate material is a sugar syrup. The high protein food bar has a mechanical hardness of less than about 2000 grams force. Suitably, the whey protein isolate is present in the high protein food bar in an amount of about 9.7% (by total weight food bar). The calcium caseinate is present in the high protein food bar in an amount of about 9.7% (by total weight food bar). Additionally, both the first and second isolated soy proteins are individually present in the high protein food bar in amounts of about 9.5% (by total weight food bar).

### EXAMPLES

The following examples are simply intended to further illustrate and explain the present disclosure. The disclosure, therefore, should not be limited to any of the details in these examples.

### Example 1

In this Example, samples of high protein food bars comprising proteinaceous material and carbohydrate material are produced. The functional properties of the high protein food bars, such as mechanical hardness and chewiness, are evaluated.

To produce the high protein food bars for evaluation in the Examples, a first mixture is produced in a Winkworth mixer (available from Winkworth Machinery, Ltd., Reading, England) mixing at a speed of 48 revolutions per minute (rpm) for one minute. The first mixture comprises: 933.4 grams proteinaceous material, 116.0 grams cocoa powder (available from DeZaan, Milwaukee, Wis.), 14.0 grams vitamin & mineral premix (available from Fortitech, Schenectady, N.Y.), 2.0 grams salt, 0.6 grams sucralose (available as Splenda® from Tate & Lyle, Inc., Decatur, Ill.), 144.0 grams cake shortening (available from BakeMark, Bradley, Ill.), and 14.0 grams lecithin (available as Centrophase 152 from The Solae Co., St. Louis, Mo.).

In a separate container, a second mixture containing carbohydrate material and liquid flavoring agents is then heated to a temperature of 37.8° C. (100° F.) by microwaving the mixture on high power for about 45 seconds. The carbohydrate material consists of a mixture of: 59.1 grams glycerin, 94.0 grams maltitol, 94.0 grams polydextrose syrup. The liquid flavoring agents consist of a mixture of: 8.0 grams Edlong Chocolate flavor 610 (available from The Edlong Corporation, Elk Grove Village, Ill.), 8.0 grams Edlong Chocolate flavor 614 (available from The Edlong Corporation, Elk Grove Village, Ill.), and 6.0 grams vanilla flavoring (available from Sethness Greenleaf, Inc., Chicago, Ill.). The first mixture is then combined with the second mixture in a Winkworth mixer and mixed at a speed of 48 rpm for three minutes and forty-five seconds. The resulting dough is then sheeted out onto a marble slab and bars are cut into pieces weighing from about 45 grams to about 55 grams (the bar pieces are about 102 millimeters in length, about 10 millimeters in height, and about 35 millimeters wide).

Eleven samples of high protein food bars comprising various proteinaceous materials are made. Two samples are made by using only isolated soy protein as the proteinaceous material. Four samples are made by using only milk protein as the proteinaceous material. The remaining samples use a blend of isolated soy protein and milk protein as the proteinaceous material.

The types of proteinaceous material, concentration of proteinaceous material, and commercial source of the proteinaceous material used in the eleven samples of high protein food bars are shown in Table 1:

TABLE 1

| High Protein Food Bar | Proteinaceous Material | |
|---|---|---|
| Sample | Isolated Soy Protein | Milk Protein |
| ISP 1 (Isolated Soy Protein 1) | 100% (FXP H0313, available | 0% |
| | from The Solae ® Co., St. Louis, | |
| | Missouri) | |
| ISP 2 (Isolated Soy Protein 2) | 100% (FXP 950, available from | 0% |
| | The Solae Co., St. Louis, | |
| | Missouri) | |
| CC (Calcium caseinate) | 0% | 100% (Calcium caseinate, available as |
| | | Farbest 290 from Farbest Brands, Montvale, |
| | | New Jersey) |
| WPI (Whey protein isolate) | 0% | 100% (WPI, available as Protient from |
| | | Protient, Inc., St. Paul, Minnesota) |
| WPC (Whey protein | 0% | 100% (WPC, available as Farbest 80 from |
| concentrate) | | Farbest Brands, Montvale, New Jersey) |
| Blend A | 50% FXP H0313 | 50% Calcium caseinate |
| Blend B | 50% FXP H0313 | 50% WPI |
| Blend C | 50% FXP 950 | 50% Calcium caseinate |
| Blend D | 50% FXP 950 | 50% WPI |
| Blend E | 33% FXP H0313 | 33% Calcium caseinate |
| | | 33% WPC |
| CC/WPC | 0% | 50% Calcium caseinate |
| | | 50% WPC |

N/A = Not Applicable

FXPH0313, which, as shown in Table 1, is an ISP 1-type isolated soy protein, has a degree of hydrolysis of 87 STNBS. FXP 950, which is an ISP 2-type isolated soy protein, has a degree of hydrolysis of 115 STNBS.

The samples of high protein food bars are then stored in metallic, moisture barrier film, available from Kapak Corporation (St. Louis Park, Minn.). The bars are stored for forty-two days at a temperature of 32.2° C. (90° F.). Storage of the bars for forty-two days at a temperature of 32.2° C. (90° F.) is statistically equivalent to storage of the bars in ambient conditions, such as on a store shelf, for eleven to twelve months.

The mechanical hardness of the samples is then measured using the TA.TXT2 texture analyzer and the method described above. Specifically, the mechanical hardness is measured at day 1 and day 42. The hardening rate of the samples is then determined using the mechanical hardness values and the method described above. The results of these measurements and calculations are shown in Table 2:

TABLE 2

| | Mechanical Hardness | | |
|---|---|---|---|
| High Protein Food Bar | (grams force) | | Hardening Rate |
| Sample | Day 1 | Day 42 | (grams/day) |
| ISP 1 (Isolated Soy | 975 | 1979 | 23.9 |
| Protein 1) | | | |
| ISP 2 (Isolated Soy | 658 | 1635 | 23.3 |
| Protein 2) | | | |
| CC (Calcium caseinate) | 999 | 5239 | 101 |
| WPI (Whey protein | 4845 | 7961 | 74.2 |
| isolate) | | | |
| WPC (Whey protein | 4373 | 6810 | 58.0 |
| concentrate) | | | |
| Blend A | 191 | 2344 | 51.3 |
| Blend B | 1983 | 4078 | 49.9 |
| Blend C | 268 | 2064 | 42.8 |
| Blend D | 1112 | 2638 | 36.3 |
| Blend E | 253 | 1678 | 33.9 |
| CC/WPC | 260 | 2878 | 32.4 |

The data in Table 2 show that, after forty-two days, the samples with only milk proteins have the highest mechanical hardness values, equating to the samples having more of a hard, brick-like texture compared to the other samples. By contrast, the samples with blended soy protein and milk protein have lower mechanical hardness values. As such, the blended samples are softer in texture. The samples with only isolated soy protein have low mechanical hardness, having mechanical hardness values of 1979 grams force and 1635 grams force. Similar mechanical hardness is shown with the Blend C and Blend E, which have mechanical hardness values of 2064 grams force and 1678 grams force respectively.

Additionally, as shown in Table 2, the samples with only milk proteins have the highest hardening rates, having hardening rates of from 58 grams/day to 101 grams/day. By contrast, the samples with blended isolated soy protein and milk protein have lower hardening rates. The samples with only isolated soy protein have the lowest hardening rates, having hardening rates of 23.9 grams/day and 23.3 grams/day. Similar hardening rates are shown with the Blend D and Blend E samples, which have hardening rates of 36.3 grams/day and 33.9 grams/day respectively.

### Example 2

In this Example, samples of high protein food bars comprising proteinaceous material and sugar syrups are produced. The functional properties of the high protein food bars, such as mechanical hardness and chewiness, are evaluated.

To obtain the high protein food bars, a first mixture is produced in a Winkworth mixer (available from Winkworth Machinery, Ltd., Reading, England) mixing at a speed of 48 revolutions per minute (rpm) for one minute. The first mixture comprises: 600.0 grams proteinaceous material, 32.4 grams rice syrup solids (available from Natural Products, Lathrop, Calif.), 76.4 grams cocoa powder (available from DeZaan, Milwaukee, Wis.), 10.5 grams vitamin & mineral premix (available from Fortitech, Schenectady, N.Y.), and 1.6 grams salt.

In a separate container, a second mixture containing liquid sugar syrups and liquid flavoring agents is then heated to a temperature of 37.8° C. (100° F.) by microwaving on high power for about 45 seconds. The liquid sugar syrup consists of 710.0 grams of a 55:45 blend of 63 DE corn syrup (available from Roquette, LESTREM Cedex, France) to high fructose corn syrup 55 (available from International Molasses Corp., Rochelle Park, N.J.) and 59.1 grams glycerin. The liquid flavoring agents consist of 4.1 grams Edlong Chocolate flavor 610 (available from The Edlong Corporation, Elk Grove Village, Ill.), 4.1 grams Edlong Chocolate flavor 614 (available from The Edlong Corporation, Elk Grove Village, Ill.), and 2.0 grams vanilla flavoring (available from Sethness Greenleaf, Inc., Chicago, Ill.). The heated second mixture is then mixed the first mixture in a Winkworth mixer at a speed of 48 rpm for three minutes and forty-five seconds. The resulting dough is then sheeted out onto a marble slab and bars are cut into pieces weighing from about 45 grams to about 55 grams (the bar pieces are about 102 millimeters in length, about 10 millimeters in height, and about 35 millimeters wide).

Four samples of high protein food bars comprising various proteinaceous materials are made. One sample is made by using only isolated soy protein as the proteinaceous material. Two samples are made using only milk proteins as the proteinaceous material. One sample is made using a blend of isolated soy protein and milk protein as the proteinaceous material.

The types of proteinaceous material, concentration of proteinaceous material, and commercial source of the proteinaceous material used in the four samples of high protein food bars are shown in Table 3:

TABLE 3

| High Protein Food Bar | Proteinaceous Material | |
|---|---|---|
| Sample | Isolated Soy Protein | Milk Protein |
| ISP 3 (Isolated Soy Protein 3) | 100% (FXP H0320, available from | 0% |
| | The Solae ® Co., St. Louis, | |
| | Missouri) | |
| WPI (Whey protein isolate) | 0% | 100% (WPI, available as Barflex, from |
| | | Glanbia Foods, Inc., Twin Falls, Idaho) |
| Dairy Blend | 0% | 50% (WPI, available as Barflex, from |
| | | Glanbia Foods, Inc., Twin Falls, Idaho) |
| | | 50% (WPC, available as Farbest, from |
| | | Farbest Brands, Montvale, New Jersey) |
| Soy-Dairy Blend | 50% FXP H0320 (available from | 50% (WPI, available as Barflex, from |
| | The Solae Co., St. (Louis, Missouri) | Glanbia Foods, Inc., Twin Falls, Idaho) |

FXP H0320, which, as shown in Table 3, is an ISP 3-type isolated soy protein, has a degree of hydrolysis of 31 STNBS.

The samples of high protein food bar are then stored in metallic, moisture barrier film, available from Kapak Corporation. Similar to Example 1, the bars were stored for forty-two days at a temperature of 32.2° C. (90° F.).

After the forty-two days, the mechanical hardness of the samples is then measured using the TA.TXT2 texture analyzer and method described above. The results of these measurements are shown in Table 4:

TABLE 4

| | Mechanical Hardness | | |
|---|---|---|---|
| High Protein Food Bar | (grams force) | | Hardening Rate |
| Sample | Day 1 | Day 42 | (grams/day) |
| ISP 3 (Isolated Soy | 1285 | 7625 | 79.5 |
| Protein 3) | | | |
| WPI (Whey protein | 495 | 3901 | 81.1 |
| isolate) | | | |
| Dairy Blend | 219 | 2990 | 66.0 |
| Soy-Dairy Blend | 154 | 791 | 15.2 |

As shown in Table 4, at day 42, the sample with soy-dairy blend has a reduced mechanical hardness compared to the other high protein food bar samples by at least about 74%. As such, the soy-dairy blend sample is softer in texture than all of the other high protein food bar samples. The sample with only isolated soy protein has the highest mechanical hardness, having a mechanical hardness of 7625 grams force.

Additionally, the sample with soy-dairy blend has the slowest hardening rate when compared to the other high protein food bar samples. As such, the soy-dairy blend sample has a longer shelf-life when compared to the other samples. The sample with only whey protein isolate has the fastest hardening rate, having a hardening rate of 81.1 grams/day.

In addition to measuring mechanical hardness and hardening rate, the chewiness of the high protein food bar samples is measured using the method described above. Specifically, five samples of the high protein food bars are evaluated each session, wherein two of the samples are the same type of high protein food bar. The replicate sample serves as an internal control. Between each sample, the trained panelists rinse their mouths with 1-2 ounces of filtered tap water (room temperature, i.e., about 25° C. (77° F.)). The results of the chewiness measurements are shown in Table 5:

TABLE 5

| High Protein Food Bar Sample | Chewiness score |
|---|---|
| ISP 3 (Isolated Soy Protein 3) | 4.3 |
| WPI (Whey protein isolate) | 15.0 |
| Dairy Blend | 12.8 |
| Soy-Dairy Blend | 6.0 |

As shown in Table 5, the chewiest food bar samples are the samples containing only milk proteins as the proteinaceous material. The least chewy food bar sample is the sample containing only isolated soy protein as the proteinaceous material. The sample containing a blend of isolated soy protein and milk protein has a chewiness score of 6.0, which, as noted above, falls within the preferred range for chewiness scores of high protein food bars.

### Example 3

In this Example, samples of a banana nut flavored baked high protein food bars comprising proteinaceous material and carbohydrate material including sugar syrups are produced.

To obtain the baked high protein food bars, a first mixture is produced in a Hobart mixer (available as Model A120 with a 12 quart bowl and paddle, from Hobart Corporation, Troy, Ohio) mixing at a low speed for one minute. The first mixture comprises: 128.8 grams proteinaceous material, 2.0 grams vitamin & mineral premix (available from Fortitech, Schenectady, N.Y.), 4.5 grams baking powder, 9.1 grams nuts (available from Novarro Pecan Company, Corsicana, Tex.), 0.8 grams vanilla flavor (available from Sethness Greenleaf, Inc., Chicago, Ill.), 2.7 grams roasted banana flavor (available from Sethness Greenleaf, Inc., Chicago, Ill.), and 15.2 grams freeze dried banana (available from VanDrunen Farms, Momence, Ill.). The proteinaceous material consists of: 28.5 grams FXP H0313 (ISP 1-type isolated soy protein, available from The Solae® Company, St. Louis, Mo.), 28.5 grams FXP H0320 (ISP 3-type isolated soy protein, available from The Solae Company, St. Louis, Mo.), 29.2 grams whey protein isolate (available as Barflex, from Glanbia Foods, Inc., Twin Falls, Id.), 29.2 grams calcium caseinate (available as Farbest 290 from Farbest Brands, Montvale, N.J.), and 13.5 grams liquid whole eggs.

In a separate container, 139.0 grams of a second mixture containing liquid carbohydrates, liquid fats and oils, and liquid flavoring agents is then heated to a temperature of 37.8° C. (100° F.) by microwaving on high power for about 12 seconds. The second mixture comprises: 31.1 grams of Fruitrim® liquid sweetener (available from Advanced Ingredients, Inc., Capitola, Calif.), 18.2 grams of high maltose 42 DE brown rice syrup (available from Briess Malt and Ingredients Company, Chilton, Wis.), 47.4 grams of isomalto-oligosaccharide (available from BioNeutra, Inc., Edmonton, Alberta, Canada), 24.0 grams of high oleic sunflower oil (available from Humko Oil Products, Memphis, Tenn.), 15.0 grams of banana puree (available from Northwest Naturals Corporation, Bothell, Wash.), 3.0 grams of lecithin (available from The Solae Company, St. Louis, Mo.), and 0.3 grams of liquid sucralose (available from Tate and Lyle, Decatur, Ill.). The heated second mixture is then mixed with the first mixture in a Hobart mixer at a low speed for one minute. The resulting dough is then placed into a mini loaf pan, the pan weighing approximately 80-90 grams per serving (the serving pieces are about 100 millimeters in length, about 24 millimeters in height, and about 55 millimeters wide). The dough is then baked at 176.7° C. (350° F.) for 6 minutes.

### Example 4

In this Example, samples of high protein food bars comprising proteinaceous material and sugar syrups are produced. The functional properties of the high protein food bars, such as mechanical hardness and hardening rate, are evaluated.

To produce the ISP 4-type isolated soy protein, ground identity preserved (IP) soy flakes are defatted with hexane and extracted at a pH of about 9.67 using sodium hydroxide (NaOH) as discussed herein above. Once the soy protein is extracted, it is suspended in water having a temperature of 36° C. (96° F.) for a period of 10 minutes. Hydrochloric acid (HCl) is then added to the suspended soy protein, lowering the pH of the suspension to about 4.45. The extract remains in the HCl solution for a period of 5 minutes to form a precipitated soy protein curd from the suspended soy protein. The precipitation separates the soy protein curd from the remaining carbohydrates and fats in the suspended soy protein. Separation is completed by centrifuging the precipitate in a Decanter centrifuge (available from Sharples Co., North Attleboro, Mass.) at a speed of 4000 revolutions per minute (rpm) and at a temperature of 36° C. (96° F.) for about 10 to about 15 seconds.

The resultant precipitated soy protein curd is then hydrated in a water solution and placed in a Cowles tank. Sodium hydroxide is added to the precipitated soy protein curd suspension to form a neutralized soy protein curd suspension having an increased pH. Sodium hydroxide is mixed with the soy protein solution for 10 minutes, raising the pH of the second solution to about 6.5. The neutralized soy protein curd slurry is then heated to a temperature of about 54° C. (129.2° F.). The heated neutralized soy protein curd slurry is then reacted with 0.15% (by weight dry neutralized soy protein curd) bromelain having an activity of 2500 BTU/gram (available from Valley Research, South Bend, Ind.) at a temperature of about 54° C. (129.2° F.) for about 35 minutes. The enzyme treated soy protein material is then heated to temperature of about 151.7° C. (305° F.) for about 9 seconds. Finally, the heated enzyme treated soy protein material is flashed cooled to a temperature of about 82° C. (180° F.) and spray dried in a co-current flow drier through a nozzle atomizer under a pressure of about 3500 psig and a temperature of about 285° C. (545° F.).

Once the proteinaceous material is obtained, the high protein food bars are prepared. To obtain the high protein food bars, a first mixture is produced in a Winkworth mixer (available from Winkworth Machinery, Ltd., Reading, England) mixing at a speed of 48 revolutions per minute (rpm) for one minute. The first mixture comprises: 600.0 grams proteinaceous material, 32.4 grams rice syrup solids (available from Natural Products, Lathrop, Calif.), 76.4 grams cocoa powder (available from DeZaan, Milwaukee, Wis.), 10.5 grams vitamin & mineral premix (available from Fortitech, Schenectady, N.Y.), and 1.6 grams salt.

In a separate container, a second mixture containing liquid sugar syrups and liquid flavoring agents is then heated to a temperature of 37.8° C. (100° F.) by microwaving on high power for about 45 seconds. The liquid sugar syrup consists of 710.0 grams of a 55:45 blend of 63 DE corn syrup (available from Roquette, LESTREM Cedex, France) to high fiuctose corn syrup 55 (available from International Molasses Corp., Rochelle Park, N.J.) and 59.1 grams glycerin. The liquid flavoring agents consist of 4.1 grams Edlong Chocolate flavor 610 (available from The Edlong Corporation, Elk Grove Village, Ill.), 4.1 grams Edlong Chocolate flavor 614 (available from The Edlong Corporation, Elk Grove Village, Ill.), and 2.0 grams vanilla flavoring (available from Sethness Greenleaf, Inc., Chicago, Ill.). The heated second mixture is then mixed with the first mixture in a Winkworth mixer at a speed of 48 rpm for three minutes and forty-five seconds. The resulting dough is then sheeted out onto a marble slab and bars are cut into pieces weighing from about 45 grams to about 55 grams (the bar pieces are about 102 millimeters in length, about 10 millimeters in height, and about 35 millimeters wide).

Three samples of high protein food bars comprising various isolated soy proteins as the proteinaceous materials are made. The types of isolated soy protein and commercial sources of the isolated soy protein used in the three samples of high protein food bars are shown in Table 6:

TABLE 6

| High Protein Food Bar | |
|---|---|
| Sample | Isolated Soy Protein |
| ISP 4 (Isolated Soy protein 4) | 100% ISP 4-type isolated soy protein |
| ISP 1 (Isolated Soy Protein 1) | 100% (FXP H0313, available from |
| | The Solae ® Co., St. Louis, Missouri) |
| ISP 3 (Isolated Soy Protein 3) | 100% (FXP H0320, available from |
| | The Solae Co., St. Louis, Missouri) |

The ISP 4-type isolated soy protein has a degree of hydrolysis of 45 STNBS. Additionally, FXP H0313 is an ISP 1-type isolated soy protein and has a degree of hydrolysis of 87 STNBS and FXP H0320, which is an ISP 3-type isolated soy protein, has a degree of hydrolysis of 31 STNBS.

The samples of high protein food bar are then stored in metallic, moisture barrier film, available from Kapak Corporation. The bars were stored for thirty-five days at a temperature of 32.2° C. (90° F.).

After the thirty-five days, the mechanical hardness of the samples is then measured using the TA.TXT2 texture analyzer and the method described above. Specifically, the mechanical hardness is measured at day 1 and day 35. The hardening rate of the samples is then determined using the mechanical hardness values and the method described above. The results of these measurements are shown in Table 7:

TABLE 7

| | Mechanical Hardness | | |
|---|---|---|---|
| High Protein Food Bar | (grams force) | | Hardening Rate |
| Sample | Day 1 | Day 35 | (grams/day) |
| ISP 4 (Isolated Soy | 115 | 220 | 3.0 |
| protein 4) | | | |
| ISP 1 (Isolated Soy | 552 | 1140 | 16.8 |
| Protein 1) | | | |
| ISP 3 (Isolated Soy | 648 | 820 | 4.9 |
| Protein 3) | | | |

As shown in Table 7, at day 35, the sample using ISP 4-type protein as the proteinaceous material has a reduced mechanical hardness compared to the other high protein food bar samples by at least about 73.2%. As such, the ISP 4-type protein sample is softer in texture than the other high protein food bar samples. The sample using ISP 1-type protein has the highest mechanical hardness, having a mechanical hardness of 1140 grams force. Additionally, the ISP 4-type protein sample has the slowest hardening rate. As such, the ISP 4-type protein sample produces a high protein food bar having a longer shelf-life as compared to the other samples.

### Example 5

In this Example, samples of high protein food bars comprising proteinaceous material and sugar syrups are produced. The functional properties of the high protein food bars, such as mechanical hardness and hardening rate, are evaluated.

The ISP 4-type isolated soy protein for use in the proteinaceous material of the high protein food bar is produced using the method in Example 4.

To obtain the high protein food bars, a first mixture is produced in a Winkworth mixer (available from Winkworth Machinery, Ltd., Reading, England) mixing at a speed of 48 revolutions per minute (rpm) for one minute. The first mixture comprises: 600.0 grams proteinaceous material, 32.4 grains rice syrup solids (available from Natural Products, Lathrop. Calif.), 76.4 grams cocoa powder (available from DeZaan, Milwaukee, Wis.), 10.5 grams vitamin & mineral premix (available from Fortitech, Schenectady, N.Y.), and 1.6 grams salt.

In a separate container, a second mixture containing liquid sugar syrups and liquid flavoring agents is then heated to a temperature of 37.8° C. (100° F.) by microwaving on high power for about 45 seconds. The liquid sugar syrup consists of 710.0 grams of a 55:45 blend of 63 DE corn syrup (available from Roquette, LESTREM Cedex, France) to high fructose corn syrup 55 (available from International Molasses Corp., Rochelle Park, N.J.) and 59.1 grams glycerin. The liquid flavoring agents consist of 4.1 grams Edlong Chocolate flavor 610 (available from The Edlong Corporation, Elk Grove Village, Ill.), 4.1 grams Edlong Chocolate flavor 614 (available from The Edlong Corporation, Elk Grove Village, Ill.), and 2.0 grams vanilla flavoring (available from Sethness Greenleaf, Inc., Chicago, Ill.). The heated second mixture is then mixed with the first mixture in a Winkworth mixer at a speed of 48 rpm for three minutes and forty-five seconds. The resulting dough is then sheeted out onto a marble slab and bars are cut into pieces weighing from about 45 grams to about 55 grams (the bar pieces are about 102 millimeters in length, about 10 millimeters in height, and about 35 millimeters wide).

Two samples of high protein food bars comprising various proteinaceous materials are made. The types of proteinaceous material, concentration of proteinaceous material, and commercial source of the proteinaceous material used in the two samples of high protein food bars are shown in Table 8:

TABLE 8

| High | | |
|---|---|---|
| Protein | Proteinaceous Material | |
| Food Bar | Isolated | |
| Sample | Soy Protein | Milk Protein |
| Blend A | 33% ISP 4-type | 33% Calcium caseinate (available as Farbest |
| | isolated | 290 from Farbest Brands, Montvale, New |
| | soy protein | Jersey); |
| | | 33% Whey Protein Concentrate (WPC, |
| | | available as Farbest, from Farbest Brands, |
| | | Montvale, New Jersey |
| Dairy | 0% | 50% Calcium caseinate (available as Farbest |
| Blend | | 290 from Farbest Brands, Montvale, New |
| | | Jersey); |
| | | 50% WPC (available as Farbest, from |
| | | Farbest Brands, Montvale, New Jersey) |

The ISP 4-type isolated soy protein has a degree of hydrolysis of 45 STNBS.

The samples of high protein food bar are then stored in metallic, moisture barrier film, available from Kapak Corporation. Similar to Example 1, the bars were stored for forty-two days at a temperature of 32.2° C. (90° F.).

After the forty-two days, the mechanical hardness of the samples is then measured using the TA.TXT2 texture analyzer and method described above. The results of these measurements are shown in Table 9:

TABLE 9

| | Mechanical Hardness | | |
|---|---|---|---|
| High Protein Food Bar | (grams force) | | Hardening Rate |
| Sample | Day 1 | Day 42 | (grams/day) |
| Blend A | 454 | 2000 | 36.8 |
| Dairy Blend | 888 | 3500 | 62.2 |

As shown in Table 9, at day 42, the sample using Blend A as the proteinaceous material has a reduced mechanical hardness compared to the other high protein food bar sample. As such, the Blend A sample is softer in texture than the other high protein food bar sample. Additionally, the sample using Blend A as the proteinaceous material has a lower hardening rate as compared to the dairy blend sample.

### Example 6

In this Example, samples of high protein food bars comprising proteinaceous material and carbohydrate material are produced. The functional properties of the high protein food bars, such as mechanical hardness and hardening rate, are evaluated.

The ISP 4-type isolated soy protein for use in the proteinaceous material of the high protein food bar is produced using the method of Example 4.

To produce the high protein food bars for evaluation in the Examples, a first mixture is produced in a Winkworth mixer (available from Winkworth Machinery, Ltd., Reading, England) mixing at a speed of 48 revolutions per minute (rpm) for one minute. The first mixture comprises: 933.4 grams proteinaceous material, 116.0 grams cocoa powder (available from DeZaan, Milwaukee, Wis.), 14.0 grams vitamin & mineral premix (available from Fortitech, Schenectady, N.Y.), 2.0 grams salt, 0.6 grams sucralose (available as Splenda® from Tate & Lyle, Inc., Decatur, Ill.), 144.0 grams cake shortening (available from BakeMark, Bradley, Ill.), and 14.0 grams lecithin (available as Centrophase 152 from The Solae® Co., St. Louis, Mo.).

In a separate container, a second mixture containing carbohydrate material and liquid flavoring agents is then heated to a temperature of 37.8° C. (100° F.) by microwaving the mixture on high power for about 45 seconds. The carbohydrate material consists of a mixture of. 59.1 grams glycerin, 94.0 grams maltitol, 94.0 grams polydextrose syrup. The liquid flavoring agents consist of a mixture of. 8.0 grams Edlong Chocolate flavor 610 (available from The Edlong Corporation, Elk Grove Village, Ill.), 8.0 grams Edlong Chocolate flavor 614 (available from The Edlong Corporation, Elk Grove Village, Ill.), and 6.0 grams vanilla flavoring (available from Sethness Greenleaf, Inc., Chicago, Ill.). The first mixture is then combined with the second mixture in a Winkworth mixer and mixed at a speed of 48 rpm for three minutes and forty-five seconds. The resulting dough is then sheeted out onto a marble slab and bars are cut into pieces weighing from about 45 grams to about 55 grams (the bar pieces are about 102 millimeters in length, about 10 millimeters in height, and 35 about millimeters wide).

Two samples of high protein food bars comprising various proteinaceous materials are made. The types of proteinaceous material, concentration of proteinaceous material, and commercial source of the proteinaceous material used in the samples of high protein food bars are shown in Table 10:

TABLE 10

| High Protein | | |
|---|---|---|
| Food Bar | Proteinaceous Material | |
| Sample | Isolated Soy Protein | Milk Protein |
| Blend A | 33% ISP 4-type isolated soy | 33% Calcium caseinate |
| | protein | 33% WPC |
| Dairy Blend | 0% | 50% Calcium caseinate |
| | | 50% WPC 0% |

The ISP 4-type isolated soy protein has a degree of hydrolysis of 45 STNBS.

The samples of high protein food bars are then stored in metallic, moisture barrier film, available from Kapak Corporation (St. Louis Park, Minn.). The bars are stored for forty-two days at a temperature of 32.2° C. (90° F.).

The mechanical hardness of the samples is then measured using the TA.TXT2 texture analyzer and the method described above. Specifically, the mechanical hardness is measured at day 1 and day 42. The hardening rate of the samples is then determined using the mechanical hardness values and the method described above. The results of these measurements and calculations are shown in Table 11:

TABLE 11

| | Mechanical Hardness | | |
|---|---|---|---|
| High Protein Food Bar | (grams force) | | Hardening Rate |
| Sample | Day 1 | Day 42 | (grams/day) |

| | | | |
|---|---|---|---|
| Blend A | 311 | 2100 | 42.6 |
| Dairy Blend | 510 | 2900 | 56.9 |

The data in Table 11 show that, after forty-two days, the sample with Blend A proteinaceous material has the lower mechanical hardness value, equating to the sample having a softer texture. Additionally, the sample with Blend A has a lower hardening rate, which corresponds to a longer shelf-life, compared to the sample with dairy blend.

Based on the disclosure herein, Table 12 summarizes a number of embodiments for the high protein food bars described herein. Specifically, Table 12 shows a number of possible combinations of various proteins within the scope of the present disclosure.

TABLE 12

| | Type of Proteinaceous Material | | | | | |
|---|---|---|---|---|---|---|
| | | | | | Co-Processed | |
| Type of | | | | | Soy | |
| Carbohydrate | | | | | Protein/Milk | Milk |
| Material | ISP 1-type | ISP 2-type | ISP 3-type | ISP 4-type | Protein Blend | Protein |
| Sugar Alcohol + Bulking | X | | | | | X |
| Agent | | | | | | |
| Sugar Alcohol + Bulking | | X | | | | X |
| Agent | | | | | | |
| Sugar Alcohol + Bulking | X | | X | | | X |
| Agent | | | | | | |
| Sugar Alcohol + Bulking | | X | X | | | X |
| Agent | | | | | | |
| Sugar Alcohol + Bulking | | | | X | | X |
| Agent | | | | | | |
| Sugar Syrup + Bulking | | | X | | | X |
| Agent | | | | | | |
| Sugar Syrup + Bulking | X | | X | | | X |
| Agent | | | | | | |
| Sugar Syrup + Bulking | | X | X | | | X |
| Agent | | | | | | |
| Sugar Syrup | | | | X | | |
| Sugar Syrup | | | | X | | X |
| Sugar Alcohol + Bulking | | | | | X | X |
| Agent | | | | | | |
| Sugar Syrup + Bulking | | | | | X | X |
| Agent | | | | | | |
| Sugar Syrup + Sugar | | | | | X | X |
| Alcohol + Bulking | | | | | | |
| Agent | | | | | | |

In view of the above, it will be seen that the several objects of the disclosure are achieved and other advantageous results obtained.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

The term “by weight” is used throughout the application to describe the amounts of components in the high protein food bars. Unless otherwise specified, the term “by weight” is intended to mean by weight on an as is basis, without any moisture added or removed from the product. The term by weight dry basis is intended to mean on a moisture-free basis, in which the moisture has been removed.

As various changes could be made in the above without departing from the scope of the disclosure, it is intended that all matter contained in the above description and shown in the accompanying drawings shall be interpreted as illustrative and not in a limiting sense.

1-29. (canceled)

30. A high protein food bar comprising from about 35% (by total weight food bar) to about 55% (by total weight food bar) proteinaceous material, and from about 35% (by total weight food bar) to about 50% (by total weight food bar) carbohydrate material, wherein the proteinaceous material comprises a combination of an isolated soy protein and a milk protein, wherein the isolated soy protein has a soluble solids index of from about 30% to about 45% and has a degree of hydrolysis of from about 40 STNBS to about 52 STNBS, wherein the carbohydrate material comprises one or more sugar alcohols and a bulking agent, and wherein the high protein food bar has a mechanical hardness of less than about 2500 grams force.

31. The high protein food bar as set forth in claim 30 wherein the proteinaceous material comprises from about 10% (by total weight proteinaceous material) to about 90% (by total weight proteinaceous material) isolated soy protein and from about 10% (by total weight proteinaceous material) to about 90% (by total weight proteinaceous material) milk protein.

32. The high protein food bar as set forth in claim 30 wherein the proteinaceous material comprises about 50% (by total weight proteinaceous material) isolated soy protein and about 50% (by total weight proteinaceous material) milk protein.

33. The high protein food bar as set forth in claim 30 wherein the milk protein is selected from the group consisting of calcium caseinate, whey protein isolate, whey protein concentrate, sodium caseinate, acid casein, skim or whole milk powder, milk protein concentrate, total milk protein, and combinations thereof.

34. The high protein food bar as set forth in claim 30 wherein the sugar alcohol is selected from the group consisting of sorbitol, maltitol, glycerin, lactitol, mannitol, isomalt, xylitol, hydrogenated starch syrups, erythritol, and combinations thereof.

35. The high protein food bar as set forth in claim 30 wherein the bulking agent is selected from the group consisting of polydextrose, starch, pectin, gelatin, xanthan, gellan, algin, guar, konjak, locust bean, fructooligosaccharides, inulin, iso-maltooligosaccharides, and combinations thereof.

36. The high protein food bar as set forth in claim 30 wherein the isolated soy protein has a degree of hydrolysis of about 45 STNBS.

37. The high protein food bar as set forth in claim 30 wherein the isolated soy protein has a soluble solids index of from about 30% to about 40%.

38. The high protein food bar as set forth in claim 30 wherein the high protein food bar has a mechanical hardness of less than about 2000 grams force.

39-47. (canceled)

48. A process for producing a high protein food bar, the process comprising:
combining a proteinaceous material and a carbohydrate material to form a dough, wherein the proteinaceous material comprises from about 10% (by total weight proteinaceous material) to about 90% (by total weight proteinaceous material) isolated soy protein and from about 10% (by total weight proteinaceous material) to about 90% (by total weight proteinaceous material) milk protein, wherein the isolated soy protein has a soluble solids index of from about 30% to about 45% and has a degree of hydrolysis of from about 40 STNBS to about 52 STNBS, and wherein the carbohydrate material comprises one or more sugar alcohols and a bulking agent;
sheeting out the dough; and
dividing the dough into individual high protein food bars.

49. The process as set forth in claim 48 wherein the high protein food bar has a mechanical hardness of less than 2500 grams force.

50. The process as set forth in claim 48 wherein the proteinaceous material comprises about 50% (by total weight proteinaceous material) isolated soy protein and about 50% (by total weight proteinaceous material) milk protein.

51. The process as set forth in claim 48 wherein the milk protein is selected from the group consisting of calcium caseinate, whey protein isolate, whey protein concentrate, sodium caseinate, acid casein, skim or whole milk powder, milk protein concentrate, total milk protein, and combinations thereof.

52. The process as set forth in claim 48 wherein the sugar alcohol is selected from the group consisting of sorbitol, maltitol, glycerin, lactitol, mannitol, isomalt, xylitol, hydrogenated starch syrups, erythritol, and combinations thereof.

53. The process as set forth in claim 48 wherein the bulking agent is selected from the group consisting of polydextrose, starch, pectin, gelatin, xanthan, gellan, algin, guar, konjak, locust bean, fructooligosaccharides, inulin, iso-maltooligosaccharides, and combinations thereof.

54. The process as set forth in claim 48 wherein the isolated soy protein has a degree of hydrolysis of about 45 STNBS.

55. The process as set forth in claim 48 wherein the isolated soy protein has a soluble solids index of from about 30% to about 40%.

56. The process as set forth in claim 48 wherein the high protein food bar comprises from about 35% (by total weight food bar) to about 55% (by total weight food bar) proteinaceous material and from about 35% (by total weight food bar) to about 50% (by total weight food bar) carbohydrate material.

57-66. (canceled)
